(19) United States
(12) Patent Application Publication
(10) Pub. No.: US 2011/0164277 A1
(43) Pub. Date: Jul. 7, 2011

(54) PRINT PROCESSING SYSTEM AND PRINT PROCESSING PROGRAM

(75) Inventors: Yuichi WADA, Wakayama-shi (JP); Shinichi HEYA, Wakayama-shi (JP); Motohiko KUBO, Wakayama-shi (JP)

(73) Assignee: NORITSU KOKI CO., LTD., Wakayama-shi (JP)

(21) Appl. No.: 12/969,528

(22) Filed: Dec. 15, 2010

Related U.S. Application Data
(62) Division of application No. 11/350,356, filed on Feb. 8, 2006, now abandoned.

(30) Foreign Application Priority Data
Feb. 9, 2005 (JP) 2005-033292
Feb. 18, 2005 (JP) 2005-042228
Feb. 18, 2005 (JP) 2005-042246
Feb. 18, 2005 (JP) 2005-042258
Feb. 18, 2005 (JP) 2005-042683

(51) Int. Cl. G06F 3/12

(52) U.S. Cl. 358/1.15

(57) ABSTRACT

There is provided a print processing system for storing image data to be subjected to printing processes in predetermined folders on an order-by-order basis and for processing the image data on the basis of the content of a printing-condition file, the print processing system comprising: first-folder setting means for setting first folders on a print-information by print-information basis; first-printing-condition-file setting means for setting first printing-condition files describing the contents of processes for image data, the first printing-condition files being stored in the first folders; second-folder creating means for creating second folders on an order-by-order basis and for storing, in the second folders, image data to be subjected to printing processes; and printing-process executing means for processing the image data in the second folders, on the basis of the contents of the first printing-condition files.

### CROSS-REFERENCE TO RELATED APPLICATIONS

This application is a divisional application of U.S. application Ser. No. 11/350,356, filed on Feb. 8, 2006, which claims priority to Japanese Patent Application No. 2005-033292, filed Feb. 9, 2005, now granted as Japanese Patent No. JP4392613, Japanese Patent Application No. 2005-042683, filed Feb. 18, 2005, Japanese Patent Application No. 2005-042228, filed Feb. 18, 2005, Japanese Patent Application No. 2005-042246, filed Feb. 18, 2005, and Japanese Patent Application No. 2005-042258, filed Feb. 18, 2005, which are hereby incorporated by reference in their entirety.

### BACKGROUND OF THE INVENTION

1. Field of the Invention

The present invention relates to print processing systems and print processing programs for storing image data to be subjected to printing processes on an order-by-order basis and for processing the image data on the basis of the content of a printing-condition file (the present invention relates to print processing systems and print processing programs for storing image data to be subjected to printing processes, in predetermined folders, on an order-by-order basis, and for processing the image data on the basis of the content of a printing-condition file).

2. Description of the Related Art

As systems for creating photograph prints, there have been known print processing systems for inputting thereto image data to be subjected to printing processes, then applying light exposure to a photograph photosensitive material for printing images thereon using the input image data, then applying developing processes thereto and then creating photograph prints. When image data is input thereto, data of the print sizes and the number of prints (corresponding to printing conditions) is defined and, thereafter, the image data and the printing conditions (referred to as order data) are stored in a folder which is referred to as a hot folder.

FIG. 8 conceptually illustrates the folder structure. In the figure, “127*89”, “127*102”, “205*254”, . . . , indicate print sizes. Namely, there are provided higher-level folders on a print-size by print-size basis. In each higher-folder, lower-level folders (sub folders) are provided on an order-by-order basis. There are illustrated Order001, Order002, as exemplary lower-folders. In each lower-level folder (sub folder), there are all the image data (image files) included in the order and a printing-condition file. The image data is stored in a predetermined file form and corresponds to order data for creating photograph prints. Further, a printing-condition file is stored for each order (in each lower-level folder). The printing-condition file is a file describing the content of processes for the image data and describes, for example, the number of prints, the presence or absence of a border on prints, information to be printed on the print back surfaces. For example, Patent Literature 1 (JP-A No. 2000-335017) discloses such printing-condition files.

Patent Literature 1 discloses a folder hierarchy formed in a storage medium for use with a digital camera, wherein IMAGE folders and a printing-job-information file (corresponding to a printing-condition file) are stored at a level lower than Root folders. The printing-condition file includes text data describing printing conditions for respective image data. The printing-condition file stored in the storage medium can be utilized in performing printing processes on the image data stored in this storage medium. In this case, generally, a single storage medium corresponds to a single order and, accordingly, the image data stored in the aforementioned storage medium and a printing-condition file are stored in, for example, Order001 in FIG. 8.

The aforementioned prior-art structure disclosed in Patent Literature 1 has the following problems. Namely, setting printing-condition files on an order-by-order basis as illustrated in FIG. 8 is a burdensome operation for an operator and, therefore, there has been a need for improvement. For example, in cases where simultaneous printing is requested, the same setting of the number of prints and the same setting of the presence or absence of a border are made for different orders, in many cases. Consequently, operators have repeatedly performed vain operations such as creation of printing-condition files having the same content, which have degraded the efficiency.

The present invention was made in view of the aforementioned circumstances and aims at providing print processing system and print processing programs which are capable of setting printing-condition files for creating photograph prints with higher efficiency.

### SUMMARY OF THE INVENTION

In order to overcome the aforementioned problems, a print processing system according to the present invention is a print processing system for storing image data to be subjected to printing processes in predetermined folders on an order-by-order basis and for processing the image data on the basis of the content of a printing-condition file, and the print processing system includes:

first-folder setting means for setting first folders on a print-information by print-information basis;

first-printing-condition-file setting means for setting first printing-condition files describing the contents of processes for image data, the first printing-condition files being stored in the first folders;

second-folder creating means for creating second folders on an order-by-order basis and for storing, in the second folders, image data to be subjected to printing processes; and

printing-process executing means for processing the image data in the second folders, on the basis of the contents of the first printing-condition files.

Also, as a preferred embodiment of the present invention, the second-folder creating means creates second folders on an order-by-order basis at the same hierarchy level as the first printing-condition files in the first folders and stores, in the second folders, image data to be subjected to printing processes.

Effects and advantages of the print processing system having the aforementioned structure will be described. In the system, image data to be subjected to printing processes is stored in second folders. Preferably, image data is stored in second folders set in first folders which are set on a print-information by print-information basis. The second folders are created on an order-by-order basis and image data to be subjected to printing processes is stored in the respective second folders

First printing-condition files are stored in the first folders and the first printing-condition files describe the contents of processes (for example, the print sizes and the number of prints) for image data. Preferably, the first printing-condition files are stored in the first folders, at the same level as the second folders.

The printing-process executing means performs processes on the image data in the second folders, according to the first printing-condition files. For example, the image data in the second folders and the first printing-condition files are transferred to a printing engine or the like. It is not necessary to provide printing-condition files in the second folders, and all the image data in the second folders can be processed according to the first printing-condition files. As a result, there is provided a print processing system capable of setting, with higher efficiency, printing-condition files used for creating photograph prints.

In the present invention, preferably, the print processing system includes:

second-printing-condition setting means for setting second printing-condition files describing the contents of processes for image data stored in the second folders, for the respective second folders, and for storing the second printing-condition files in the second folders, wherein the printing-process executing means performs processes on the basis of the second printing-condition files, when there are the second printing-condition files in the second folders.

By storing the first printing-condition files in the first folders, orders in a single first folder can be processed according to the corresponding file. However, there may be a need for performing printing processes on a certain order, under a condition different from that defined in the first printing-condition files. For example, there may be a need for changing the number of prints for certain image data. In this case, a second printing-condition file is set for the order and is set in the second folder corresponding to the order. This can cause the order to be subjected to printing processes preferentially on the basis of the second printing-condition file, rather than on the basis of the first printing-condition files. As a matter of course, orders for which no second printing-condition file is set in the corresponding second folders can be subjected to printing processes, on the basis of the first printing-condition files. This enables performing printing processes in consideration of requirements of respective orders.

In order to overcome the aforementioned problems, a print processing program according to the present invention is a print processing program for storing image data to be subjected to printing processes in predetermined folders on an order-by-order basis and for processing the image data on the basis of the content of a printing-condition file, the print processing program causes a computer to execute the steps of:

setting folders on a print-information by print-information basis;

setting first printing-condition files describing the contents of processes for image data, the first printing-condition files being stored in the first folders;

creating second folders on an order-by-order basis and storing, in the second folders, image data to be subjected to printing processes; and

printing the image data in the second folders, on the basis of the contents of the first printing-condition files.

In the present invention, preferably, the computer is caused to execute a process for creating second folders at the same hierarchy level as the first printing-condition files in the first folders.

In the present invention, preferably, the computer is caused to execute the steps of:

setting second printing-condition files describing the contents of processes for image data stored in the second folders, for the respective second folders, and storing the second printing-condition files in the second folders; and

printing the image data in the second folders, on the basis of the second printing-condition files, when there are the second printing-condition files in the second folders.

The aforementioned print processing system offers effects and advantages as previously described.

Further, in the present invention, the print processing system further includes:

an order monitoring system function of checking the states of order data on the basis of the folder names of the second folders and monitoring the second folders, the order monitoring system including;

event-data receiving means for receiving event data which is transmitted when a folder name has been changed;

order checking means for checking whether or not there is a new order in a hot folder, in response to the reception of the event data; and

order-data transferring means for, when there is a new order, transferring the order data to a predetermined transfer destination in order to cause the order data to be subjected to photograph processes.

The present invention was made in order to overcome the following problems. Namely, conventional photograph processing systems are provided with an order monitoring system (for example, JP-A No. 2000-118095) and, in order to check whether or not there is stored a new order in a storage means referred to as a hot folder, the order monitoring system is required to poll the content of the hot folder, at regular time intervals. The polling has been executed at, for example, several-second intervals, thereby causing the problem of degradation of the performance of the entire photograph processing system.

Therefore, the present invention having the aforementioned structure was made in view of the aforementioned problem.

Effects and advantages of the order monitoring system having the aforementioned structure will be described. Order data to be subjected to photograph processes is stored in storage means referred to as a hot folder on a folder-by-folder basis, and the order data is stored in the respective folders. The folders correspond to second folders. Folder names are attached to the individual second folders, and the attached folder names are indicative of the states of the order data. For example, when a second folder is being created (order data is being introduced thereto), a folder name indicative of this state is attached to the folder and, when the introduction of the order data has been completed, the folder name is changed to a folder name indicating that the order data can be subjected to photograph processes. When the folder name has been changed, the event-data receiving means receives event data indicating the fact. In response to the reception of the event data, the order checking means checks whether or not there is a new order in the hot folder. When there is a new order, the order data stored in the corresponding second folder is transferred to a predetermined transfer destination, in order to cause the order data to be processed.

Here, the “hot folder” is a folder set in a large-capacity storage device such as a hard disk and image data to be subjected to printing processes is stored therein on an order-by-order basis. Here, “a single order” means frame image data stored a single photograph film or frame image data stored in a single storage medium, in cases where image data is acquired from photograph films or storage mediums (for example, digital-camera storage mediums). In order to manage order data in the hot folder on an order-by-order basis, folders are created in the hot folder and the order data is stored in the folders. Namely, in performing printing processes, a new folder is created in the hot folder and order data to be subjected to photograph processes, such as image data, is stored therein.

However, the present invention enables checking new orders in the hot folder in the event of the reception of event data, rather than monitoring the content of the hot folder at regular time intervals, thereby preventing the degradation of the efficiency of the entire system due to vain processes. Consequently, there is provided an order monitoring system capable of monitoring new orders to be subjected to photograph processes, without degrading the efficiency of the entire system.

Further, in the present invention, preferably, at least a first extension indicating that the folder is being created or a second extension indicating that an order has been registered therein is selectively attached to the folder names of the second folders for storing order data, and the order checking means determines whether or not orders are new orders, on the basis of the second extension.

By attaching extensions to the folder names of second folders, it is possible to enable checking the states of the orders. Namely, a first extension indicating that the folder is being created or a second extension indicating that an order has been registered therein is selectively attached thereto. For example, when the creation of a folder has been completed (an order has been registered therein), the extension thereof is changed from the first extension to the second extension. This enables easily checking whether or not orders are new orders, by checking whether or not their folder names include the second extension.

Further, in the present invention, preferably, the event data includes data indicative of the type of the extension of the folder name.

By making it possible to determine the type of the extension of the folder name from the event data, it is possible to eliminate vain processes such as checking the content of the hot folder when the event is the change to an irrelevant extension.

In the present invention, preferably, data stored in a second folder includes image-data files to be subjected to photograph processes and a command data file describing the contents of processes for the image data.

The command data is a data file defining printing conditions and describes the print sizes of photograph prints, the number of prints, the content of data to be printed on the print back surfaces and the like. On the basis of the command data and the image data, photograph prints can be created.

Further, an order monitoring program having the function of monitoring orders according to the present invention is an order monitoring program for checking the states of order data on the basis of the folder names of the second folders and for monitoring the second folders, and the order monitoring program causes the computer to execute the steps of;

receiving event data which is transmitted when a folder name has been changed;

checking whether or not there is a new order in a hot folder, on receiving the event data; and

when there is a new order, transferring the order data to a predetermined transfer destination, in order to cause the order data to be subjected to photograph processes.

Further, the computer is caused to execute the step of;

selectively attaching at least a first extension indicating that the folder is being created or a second extension indicating that an order has been registered therein, to the folder names of the second folders for storing order data, and determining whether or not orders are new orders, on the basis of the presence of the second extension.

The aforementioned computer programs offer effects and advantages as previously described.

A print processing system according to the present invention is a print processing system for drawing paper from paper magazines housing the paper and for forming images on the paper surface on the basis of the image data stored in a hot folder, and the print processing means further includes;

magazine attachment/detachment detecting means for detecting the detachment of the paper magazines;

order checking means which, when the magazine attachment/detachment detecting means detects the detachment of a paper magazine, checks whether or not there is an unprocessed order for the print size corresponding to this paper magazine; and

unprocessed-order displaying means which, when there is an unprocessed order, displays the fact;

wherein the first-folder setting means sets first folders corresponding to the paper housed in the mounted paper magazines; and the second-folder creating means creates, in the first folders, second folders for storing image data to be subjected to printing processes.

The present invention was made in order to overcome the following problems. As a method for outputting image data to a printing engine of a conventional print processing system, there is a method which employs a storage means referred to as a hot folder. In performing printing processes, folders for storing image data on an order-by-order basis are created, and then image data of a single order and a printing-condition file is stored in each folder. The printing-condition file is a file defining printing conditions such as the print sizes, the number of prints. A printing-condition file is created for each order and is stored in each sub folder along with image data.

According to the aforementioned method, operators are required to recognize the print sizes which are currently available for printing processes and, therefore, the operators are required to have experiences and skills. One or more paper magazines can be mounted on a photograph processing device, and it is necessary to grasp the print sizes available from the currently-mounted paper magazines, for printing processes.

In order to avoid the aforementioned problem, it is possible to employ a method of creating, in advance, folders (print-size folders) corresponding to the print sizes which are currently available for printing processes. Paper magazines hold information about the paper housed therein (the size, the surface quality and the like) and, by reading the information, it is possible to recognize the print sizes which can be subjected to printing processes with the currently-mounted paper magazines. Accordingly, the information can be read, then print-size folders can be created and sub folders can be created therein on an order-by-order basis. In cases where plural paper magazines can be mounted, plural print sizes can be treated and, therefore, plural print-size folders are created. This enables an operator to perform printing processes while checking the pre-created print-size folders.

Further, with the aforementioned structure, in cases where the paper housed in the paper magazines has been consumed or where another paper magazine housing paper of a different size is mounted, the print-size folder corresponding to the to-be-replaced paper magazine is erased.

However, there may be still an unprocessed order in the to-be-erased folder, which makes it impossible to erase the folder. Since the replacement of paper magazines may be frequently performed, there is the possibility of the problem of existence of unprocessed orders.

On the other hand, Patent Literature 2 (JP-A No. 2001-174938) discloses a method for performing printing processes for sizes having widths which do not match the width of the paper housed in a paper magazine, after the paper magazine is mounted instead of a previously-mounted paper magazine. In order to attain that, this method provides a layout means for determining a layout which minimizes the waste of the paper and performs printing processes in accordance with such a layout.

By changing the layout for printing processes, it is possible to perform printing even after the replacement of a paper magazine. However, this may cause wastes of paper depending on the paper size, which is not preferable.

The present invention was made in view of the aforementioned circumstances and aims at providing a print processing system capable of preventing unprocessed orders from being erased before they are processed, when a paper magazine is to be replaced (or when the paper magazine has been replaced).

Hereinafter, there will be described effects and advantages of the print processing system having the structure according to the present invention. The print processing system forms images on the surface of paper, on the basis of image data stored in a storage means referred to as a hot folder. A single or more paper magazines housing paper are detachably provided on the device and, there is provided a magazine attachment/detachment detecting means for detecting the detachment of the paper magazines. First folders (print-size folders) corresponding to the print sizes which can be processed with the paper housed in the paper magazines are created. In the first folders (print-size folders), second folders are created on an order-by-order basis. Image data of an order is stored in each second folder.

Further, when the magazine attachment/detachment detecting means detects the detachment of a paper magazine, it is checked whether or not there is an unprocessed order for a print size corresponding to the paper magazine. The term “when the detachment of a paper magazine is detected” means, for example, when the actual disengagement of a paper magazine from the device is detected, when the locking of a paper magazine is released, or when the detachment of a paper magazine is specified on a monitor screen.

When there is an unprocessed order, this fact is displayed. This enables an operator to take measures thereagainst, such as re-mounting the detached paper magazine, moving the folder storing the unprocessed order to another directory or backing up the folder. This can prevent unprocessed orders from being erased before being processed, when a paper magazine is to be replaced (when a paper magazine has been replaced).

In the present invention, preferably, the print processing system further includes;

magazine replacement specification means for specifying the replacement of a paper magazine in advance; and

order preferentially-processing means for preferentially processing orders relating to the specified paper magazine.

By providing the magazine replacement specification means, it is possible to indicate, in advance, paper magazines to be replaced. This prevents paper magazines from being detached at states where there are still unprocessed orders and also enables preferentially processing orders relating to the to-be-replaced paper magazines.

In the present invention, preferably, the print processing system further includes;

processability determination means which, when it has been determined that there is an unprocessed order, determines whether or not it can be processed with the other paper magazine; and

order moving means which, when it can be processed, moves the order to the first folder corresponding to this paper magazine.

For example, when there is still an unprocessed order for a print size having a width of 127 mm and a feeding length of 89 mm, in the case where a print size having a width of 89 mm and a feeding length of 127 mm is to be processed with the other paper magazine which is currently mounted or the to-be-newly-mounted magazine, the unprocessed order can be also processed therewith by moving the order to the corresponding print-size folder.

Further, the print processing system according to the present invention is a print processing system for forming images on the surfaces of paper drawn from paper magazines to create prints, wherein the paper magazines housing the paper are detachably mounted to the device main body; and the print processing system includes;

list displaying means for displaying a list of printing conditions which can be processed with the device;

processability determination means for determining whether or not the printing conditions can be processed with the currently-mounted paper magazines; and

condition specification means for specifying, out of the printing conditions displayed in the list, a condition to be subjected to printing processes;

wherein the list displaying means displays the printing conditions in such a manner as to indicate whether or not they can be currently processed.

The present invention was made in order to overcome the following problems. That is, there is a method which employs a folder referred to as a hot folder, as a method for outputting image data to the printing engine of a conventional print processing system. Further, there is known a printing specification device disclosed in, for example, Patent Literature 3 (JP-A No. 2004-110738), as a well-known technique for setting printing-condition files in the hot folder.

According to the aforementioned method, operators are required to recognize the print sizes which are currently available for printing processes and, therefore, the operators are required to have experiences and skills. One or more paper magazines can be mounted on a photograph processing device, and it is necessary to grasp, in receiving purchase orders, the print sizes available from the currently-mounted paper magazines, for printing processes.

Further, there are various types of paper widths, surface qualities and the like and, there is a need for setting desired paper according to the requirements of customers who make purchase orders for prints. However, there is a limit to the number of paper magazines which can be mounted on the device main body. Accordingly, it is necessary to replace the paper magazines as required, during printing processes. This requires grasping the print sizes available from currently-unmounted paper magazines for printing processes, thereby requiring operator's complicated operations.

The present invention was made in view of the aforementioned circumstances and aims at providing a print processing system and a print processing program which enable easily recognizing printing conditions which can be subjected to printing processes.

Effects and advantages of the print processing system according to the present invention will be described. This system is capable of displaying a list of printing conditions which can be processed with the device. In this list, there are also displayed printing conditions available from the currently-mounted paper magazines and also printing conditions which can be made available by replacing the paper magazines. This enables an operator to easily recognize the printing conditions available for printing conditions in the device, by seeing the list. Further, the list displays whether or not the printing conditions are available from the currently-mounted paper magazines. This enables easily recognizing whether or not the printing conditions involve replacement of paper magazines even when they are available.

When an operator intends to perform a printing process, the operator can specify the printing condition used for the printing process, by seeing the list. This can eliminate the necessity of operator's efforts to set the printing condition out of nothing and operator's operations for determining whether or not printing conditions are available for printing processes. As a result, there is provided a print printing system which enables easily recognizing the printing conditions available for printing processes.

Preferably, in the present invention, the printing conditions include information about the print sizes.

One of the most important information in a printing condition is the print size. The print size is defined by the paper width and the feeding length and is a most important factor for determining whether or not the printing condition is available.

In the present invention, preferably, the print processing system includes;

first-folder setting means for setting first folders for respective currently-processible printing conditions; and

second-folder creating means for creating, in the first folders, second folders for storing image data to be subjected to printing processes, on an order-by-order basis.

In cases where it is determined whether or not image data can be processed on the basis of the printing condition, it is preferable that first folders are set for the respective currently-available printing conditions. For example, folders are created for the respective print sizes. In the first folders, second folders are created for the respective orders, and image data of a single order is stored in each second folder. When an order is subjected to printing processes, the image data in the second folder corresponding to the order is used for performing the printing processes. This enables easily recognizing that the printing conditions corresponding to the set first folders are immediately available for printing processes without involving the replacement of a paper magazine.

In the present invention, preferably, the first-folder setting means attaches, to the first folders, a folder name indicative of the printing condition.

For example, the folder names may include the printing condition (for example, a numerical value indicating the print size) to enable easily determining which first folder should be used for storing order data.

In the present invention, preferably, the print processing system includes;

magazine attachment/detachment detecting means for detecting the detachment of paper magazines; and

paper-information detecting means for detecting information about paper housed in the paper magazines which have been detected to be mounted;

wherein the first-folder setting means sets first folders, on the basis of the detected paper information.

First folders are set for only the currently-mounted paper magazines. Therefore, by detecting the attachment/detachment of a paper magazine and detecting the paper information in response to the detection of the attachment/detachment, it is possible to create a first folder corresponding to the printing condition. This enables easily setting first folders.

In the present invention, preferably, the print processing system includes;

folder erasing means which, when the magazine attachment/detachment detecting means detects the disengagement of a paper magazine, erases the first folder set on the basis of the mounting of this paper magazine.

When a paper magazine has been detached, the first folder set for the paper magazine is no longer necessary. Therefore, there is provided the folder erasure means for erasing the first folder. This enables setting only the first folders corresponding to the printing conditions available from the currently-mounted paper magazines.

Further, a print processing program according to the present invention is a print processing program for forming images on the surfaces of paper drawn from paper magazines to create prints, wherein the paper magazines housing the paper are detachably mounted to the main body of a device, and the print processing program causes a computer to execute the steps of;

displaying a list of printing conditions which can be processed with the device;

determining whether or not the printing conditions can be processed with the currently-mounted paper magazines; and

displaying the printing conditions in such a manner as to indicate whether or not they can be currently processed.

The aforementioned program offers effects and advantages as previously described.

Further, a print processing system according to the present invention is an image forming system including an image forming device (photograph-print creating device) and one or more information processing devices (terminal processing devices) connected to the image forming device (photograph-print creating device), the image forming device being for capturing image data, performing image processing on the captured image data to create printing image data and outputting the printing image data, and the information processing devices includes;

means for capturing image data (image-data inputting portion);

means for performing image processing on the captured image data to create printing image data (image processing portion);

means for storing image information including the printing image data and process information about the printing image data (order-data storage portion); and

means for transmitting the stored image information to the image forming device (data transmitting/receiving portion);

the image forming device comprising;

an image-information receiving portion for receiving image information (data transmitting/receiving portion);

an image-information storage portion for storing the image information received by the image-information receiving portion (hot folder);

a determination portion for determining whether or not it is necessary to secure a data storage region in the image-information storage portion; and

a notification portion for generating a notification of information about the storage region, when the determination portion determines that it is necessary to secure a storage region.

The present invention was made in order to overcome the following problems in the prior art. Conventionally, when a large amount of image files to be subjected to image processing are accumulated in a storage region (hereinafter, referred to as a hot folder) and, thus, the free space of the storage region has been reduced, malfunctions have occurred during processing of image files, in some cases. In order to overcome such a problem, there has been provided a method which permits data files of image data to be transferred from a data-file server to a data file processing device, only when there is a free space equal to or greater than a predetermined capacity, in the storage region thereof (Patent Literature: JP-A No. 2003-323321). Further, there is a method which transfers data files of image data to a printing means and then erases the unnecessary data files which have been subjected to data-file processes from the storage region to secure a free space in the storage region (Patent Literature: JP-A No. 2003-323321).

However, according to the aforementioned conventional technique, when there is not enough free space in the hard disk incorporated in the image forming device, it is prohibited to transfer image-data files stored in an information processing device connected to the image forming device to the hard disk. Consequently, the information processing device is prevented from transmitting image-data files and is forced to interrupt operations and wait until a storage region is secured in the hard disk of the image forming device, thereby causing the problem of increases of the bother of performing operations such as re-transmission of image data. Furthermore, there have been cases where a user of the image forming device continuously performs photograph printing operations and occupies the photograph printing function of the image forming device, without being aware of the fact that it is prohibited to accumulate image-data files from the information processing device into the hard disk, due to the reduction of the storage region of the hard disk for image files. Then, after the completion of the operations, the user retrieves image data-files from the hard disk and prints photographs on the basis of the image files. In such cases, the user occupies the photograph printing function of the image forming device, which causes delays of photograph printing processes on image-data files from the information processing device, thereby preventing immediate photograph printing, in the event of the necessity of urgent photograph printing. Further, even if an attempt is made to preferentially process image-data files from the information processing device, it is impossible to immediately perform this. Also, even if it is possible to perform this, this will involve burdensome procedures and complicated operations, thus resulting in degradation of the quality of photograph printing.

Hereinafter, effects and advantages of the print processing system (image forming system) according to the present invention will be described. That is, with the aforementioned image forming system, a user can recognize the fact that the free space of the storage portion has been reduced and can output image information stored in the image-information storage portion. By outputting image information, it is possible to secure a free space, which enables receiving image information without interrupting the reception of image information transmitted from the information processing device. This can eliminate the necessity of burdensome double-transmission operations in the information processing device and also can eliminate the necessity of complicated operations in the image forming device, thus preventing the degradation of the quality of photograph printing.

Further, in the present invention, the image forming device further includes a data transferring portion for transferring image information stored in the image-information storage portion, when the determination portion determines that it is necessary to secure a storage region.

With the aforementioned image forming system, image information can be automatically transferred to the outputting portion when a notification of information about the storage region is generated, which can improve the operation efficiency of the entire system.

Further, in the present invention, the image forming device further includes an image-information transfer controlling portion for receiving a command for outputting image information stored in the image-information storage portion and, when the image-information transfer controlling portion receives the command, the transferring portion transfers image information stored in the image-information storage portion.

With the aforementioned image forming system, image information can be output to enable storing new image information, in response to a command received by the image-information transfer controlling portion, regardless of the shortage of the free space of the storage portion, which enables performing photograph printing operations in the image forming device, with higher efficiency, without interrupting operations for a long time.

Further, an image forming device constituting a print processing system according to the present invention is an image forming device including an image-data capturing portion for capturing image data, an image processing portion for performing image processing on the image data captured by the image capturing portion to create printing image data and an outputting portion for outputting the printing image data created by the image processing portion and the image forming device includes;

an image-information capturing portion for capturing image information including printing image data;

an image-information storage portion for storing the image information captured by the image-information capturing portion;

a determination portion for determining whether or not it is necessary to secure a data storage region in the image-information storage portion; and

a notification portion for generating a notification of information about the storage region, when the determination portion determines that it is necessary to secure a storage region.

With the aforementioned image forming system, a user can recognize the fact that the free space of the storage portion has been reduced and can output image information stored in the image-information storage portion. By outputting image information, it is possible to secure a free space, which enables receiving image information without interrupting the reception of image information transmitted from the information processing device. This can eliminate the necessity of burdensome double-transmission operations in the information processing device and also can eliminate the necessity of complicated operations in the image forming device, thus preventing the degradation of the quality of photograph printing.

Further, the image forming device according to the present invention further includes a transferring portion for transferring image information stored in the image-information storage portion to the outputting portion, when the determination portion determines that it is necessary to secure a storage region.

With the aforementioned image forming system, image information can be automatically transferred to the outputting portion when a notification of information about the storage region is generated, which can improve the operation efficiency of the entire system.

Further, the image forming device according to the present invention further includes an image-information transfer controlling portion for receiving a command for outputting image information stored in the image-information storage portion and, when the image-information transfer controlling portion receives the command, the transferring portion transfers image information stored in the image-information storage portion to the outputting portion.

With the aforementioned image forming system, image information can be output to enable storing new image information, in response to a command received by the image-information transfer controlling portion, regardless of the shortage of the free space of the storage portion, which enables performing photograph printing operations in the image forming device, with higher efficiency, without interrupting operations for a long time.

Further, in the image forming device according to the present invention, the command for outputting image information is generated when the outputting process on printing image data resulted from processing by the image processing portion has been completed.

The aforementioned structure enables detecting the completion of the outputting process of print image data, which enables reading and outputting image information stored in the image-information storage portion, thererafter.

Further, in the image forming device according to the present invention, the determination portion calculates the capacity of the free space of the image-information storage portion for storing data and determines whether or not the calculated capacity of the free space is equal to or greater than a predetermined capacity, and, if the calculated capacity of the free space is not equal to or greater than the predetermined capacity, the notification portion generates a notification of information about the storage region.

With the aforementioned structure, the capacity of the free space of the image-information storage portion can be calculated. Accordingly, when there is not enough free space in the image information storage portion, a notification of reduction of the free space can be generated, before it becomes completely impossible to store image information.

Also, an image forming device according to the present invention includes:

means for capturing image information including image data to be used for printing photographs;

means for accumulating the captured image information; and

means for generating a notification of information about the storage region, if the accumulated image information reaches a predetermined capacity or if the free space of a recording medium into which image information is accumulated becomes equal to or smaller than a predetermined capacity.

Also, an image forming device according to the present invention includes:

means for capturing image information including image data to be used for printing photographs;

means for accumulating the captured image information; and

means for performing printing processes on the accumulated image information, when a printing process performed on printing image data resulted from image processing on image data which has been captured separately from the accumulated image information has been completed.

Further, a program for realizing processes in an image forming device constituting a print processing system according to the present inventions is a program for causing a computer to execute:

an image-information reception step for receiving image information including printing image data;

an image-information accumulation step for accumulating the image information received at the image-information reception step;

a determination step for determining whether or not it is necessary to secure a data storage region in a recording medium which is the destination of accumulation at the image-information accumulation step; and

a notification step for generating a notification of information about the storage region, when it is determined at the determination step that it is necessary to secure a storage region.

The aforementioned program offers the same effects and advantages as those described above.

Further, a program for realizing processes in an image forming device constituting a print processing system according to the present inventions is a program for causing a computer to execute:

an image-information reception step for receiving image information including printing image data;

an image-information accumulation step for accumulating the image information received at the image-information reception step;

an image-information transfer controlling step for receiving a notification of the completion of a printing process performed on printing image data resulted from image processing on image data which has been acquired separately from the image information accumulated at the image-information accumulation step;

a transfer step for transferring the accumulated image information, on receiving the notification at the image-information transfer controlling step; and

an outputting step for outputting the image information transferred at the transfer step.

### BRIEF DESCRIPTION OF THE DRAWINGS

FIG. 1 is a schematic diagram illustrating the entire structure of a print processing system.

FIG. 2 is a block diagram illustrating the functions of the print processing system according to a first embodiment.

FIG. 3 is a view illustrating an exemplary folder hierarchical structure in a hot folder according to the first embodiment.

FIG. 4 is a view illustrating a printing-condition file according to the first embodiment.

FIG. 5 is a flow chart illustrating the general procedure until the creation of sub folders according to the first embodiment.

FIG. 6 is a flow chart illustrating the procedure for a printing process until the creation of sub folders according to the first embodiment.

FIG. 7 is a view illustrating an exemplary folder hierarchical structure according to the first embodiment (another embodiment).

FIG. 8 is a view illustrating an exemplary conventional folder hierarchical structure according to the first embodiment.

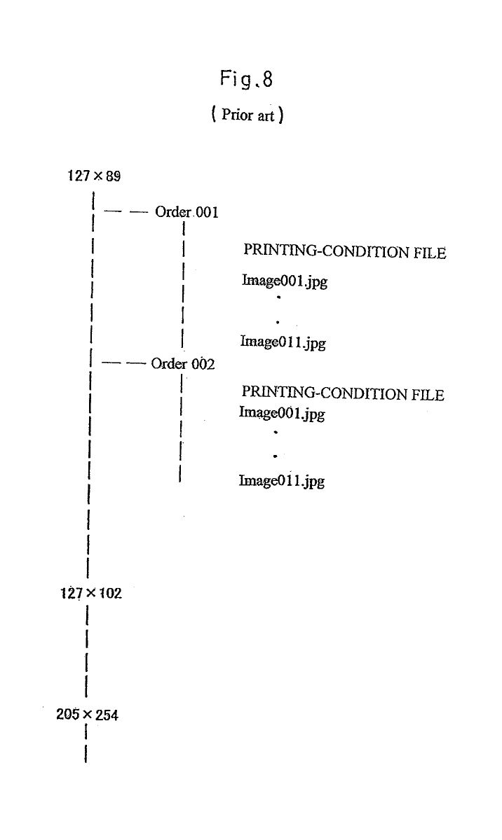

FIG. 9 is a block diagram illustrating the functions of a photograph processing system according to a second embodiment.

FIG. 10 is a view illustrating command data, according to the second embodiment.

FIG. 11 is a flow chart illustrating the general procedure until the creation of sub folders according to the second embodiment.

FIG. 12 is a flow chart illustrating the procedure for a printing process until the creation of sub folders according to the second embodiment.

FIG. 13 is a block diagram illustrating the functions of the print processing system according to a third embodiment.

FIG. 14 is a block diagram illustrating hot-folder addressing software, according to the third embodiment.

FIG. 15 is a view illustrating an extemporary structure of a printing-condition file according to the third embodiment.

FIG. 16 is a view illustrating an exemplary folder hierarchical structure in a hot folder according to the third and fourth embodiments.

FIG. 17 is a flow chart illustrating the procedure for replacement of a paper magazine according to the third embodiment.

FIG. 18 is a flow chart illustrating the procedure for replacement of a paper magazine according to the third embodiment.

FIG. 19 is a flow chart illustrating the procedure for replacement of a paper magazine according to the third embodiment.

FIG. 20 is a block diagram illustrating the functions of the print processing system according to the fourth embodiment.

FIG. 21 is a block diagram illustrating hot-folder addressing software, according to the fourth embodiment.

FIG. 22 is a view illustrating an exemplary displayed list of print sizes, according to the fourth embodiment.

FIG. 23 is a view illustrating an extemporary structure of a printing-condition file according to the fourth embodiment.

FIG. 24 is a flow chart illustrating the procedure until the setting of a print-size folder, according to the fourth embodiment.

FIG. 25 is a flow chart illustrating the procedure for replacement of a magazine according to the fourth embodiment.

FIG. 26 is a block diagram illustrating the structure of an image forming system according to a fifth embodiment.

FIG. 27 is a flow chart illustrating the operation of an image processing device, according to the fifth embodiment.

FIG. 28 is a flow chart illustrating the operation of the image processing device, according to the fifth embodiment.

FIG. 29 is a flow chart illustrating the operation of the image processing device 200, according to the fifth embodiment.

FIG. 30 is a view illustrating exemplary printing image data, according to the fifth embodiment.

FIG. 31 is a view illustrating an exemplary command file, according to the fifth embodiment.

FIG. 32 is a view illustrating an exemplary hot folder, according to the fifth embodiment.

FIG. 33 is a view illustrating an exemplary displayed screen on a liquid crystal display, according to the fifth embodiment.

### DETAILED DESCRIPTION OF THE PREFERRED EMBODIMENTS

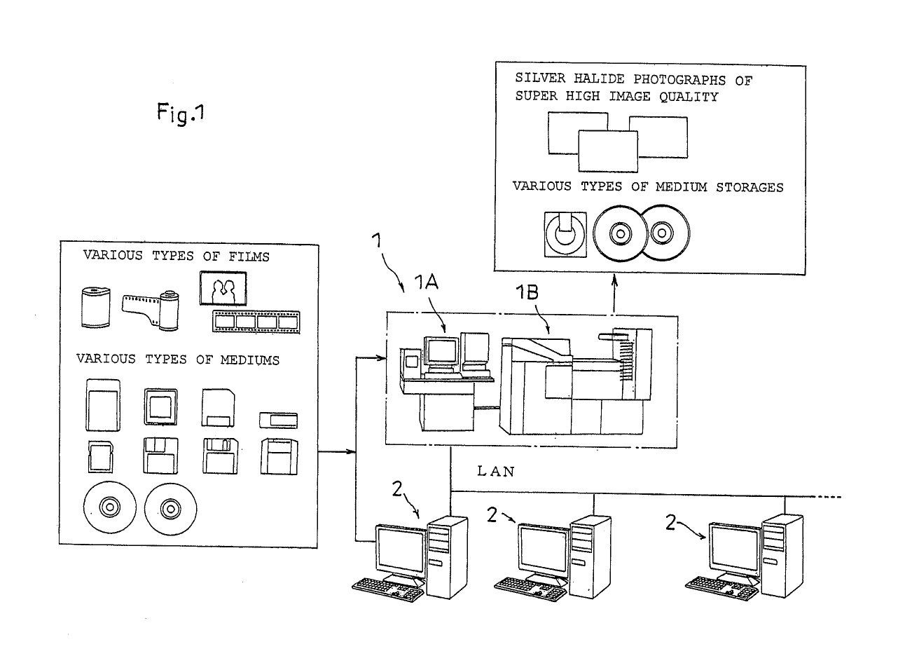

Preferred embodiments of a print processing system according to the present invention will be described, with reference to the drawings. FIG. 1 is a schematic diagram illustrating the entire structure of the print processing system.

[The Entire Structure of the Print Processing System]

In FIG. 1, a photograph processing system includes a photograph-print creating device 1 and plural terminal processing devices 2 which are connected to one another through a network such as a LAN. The photograph-print creating device 1 has the function of acquiring image data and then, on the basis of the image data, creating photograph prints or writing it into various types of storage mediums (corresponding to photograph processes). The photograph-print creating device 1 can be roughly divided into an image processor 1A and a printer processor 1B. The image processor 1A and the printer processor 1B are separate devices which are connected to each other through a communication line. However, the image processor 1A and the printer processor 1B are not limited thereto and may be integrated with each other into the photograph-print creating device 1.

The image processor 1A has the function of acquiring image data from photograph films or storage mediums. There is provided a film scanner for scanning frame images formed on developed photograph films to acquire image data. Further, there is provided a driving device for reading image data stored in various types of storage mediums. Such storage mediums may be, for example, CD-Rs, DVDs, MO disks, various types of digital camera mediums and the like.

In the image processor 1A, there is installed image processing software for enabling an operator to perform image processing operations. These image processing operations are performed for creating photograph prints with proper image qualities and include, for example, the setting of correction parameters about colors and densities, the setting of correction parameters about specific corrections such as red-eye correction and back-light correction, the settings of the print size and the number of prints. Thus, input original image data and correction parameters for the respective image data are prepared and, on the basis of these data, photograph prints can be created.

The printer processor 1B has the function of creating photograph prints, on the basis of image data and correction parameters transmitted from the image processor 1A. Therefore, the printer processor 1B is provided with an image light-exposure portion and a developing processing portion. The image light-exposure portion includes a digital light-exposure engine and has the function of applying light exposure to the emulsion surface of a photograph photosensitive material in a scanning manner for forming images thereon. The light-exposure engine may be a light-exposure engine with a proper configuration, such as a laser engine, a PLZT engine, a CRT engine. The photograph photosensitive material having an image which has been printed thereon with light exposure is transferred to the developing processing portion where it is developed. Then, the photograph photosensitive material is subjected to a drying process and then is discharged as a finished photograph print to the outside of the device.

Also, the photograph-print creating device 1 performs processes for wringing, onto storage mediums, image data which has been subjected to image processes by the image processor 1A. The device for writing data onto mediums may be mounted in the image processor 1A.

The terminal processing devices 2, which are connected to the photograph-print creating device 1 through a LAN, may be constituted by general-purpose personal computers (computers) and, software necessary for performing photograph processing operations is installed therein. The terminal processing devices 2 are capable of acquiring image data from photograph films and storage mediums, similarly to the photograph print creating device 1. Further, the terminal processing devices 2 enable performing image processing operations therein, similarly to the photograph-print creating device 1A. By placing a plurality of such terminal processing devices 2, operations can be dispersed therein, thereby increasing the processing efficiency of the entire system. By transferring data for creating photograph prints from the terminal processing devices 2 to the photograph-print creating device 1, photograph prints can be created in the photograph-print creating device 1. Also, instead of connecting only a single photograph-print creating device 1 to the LAN, a plurality of photograph-print creating devices can be connected to the LAN.

### First Embodiment

### [Functional Block Diagram]

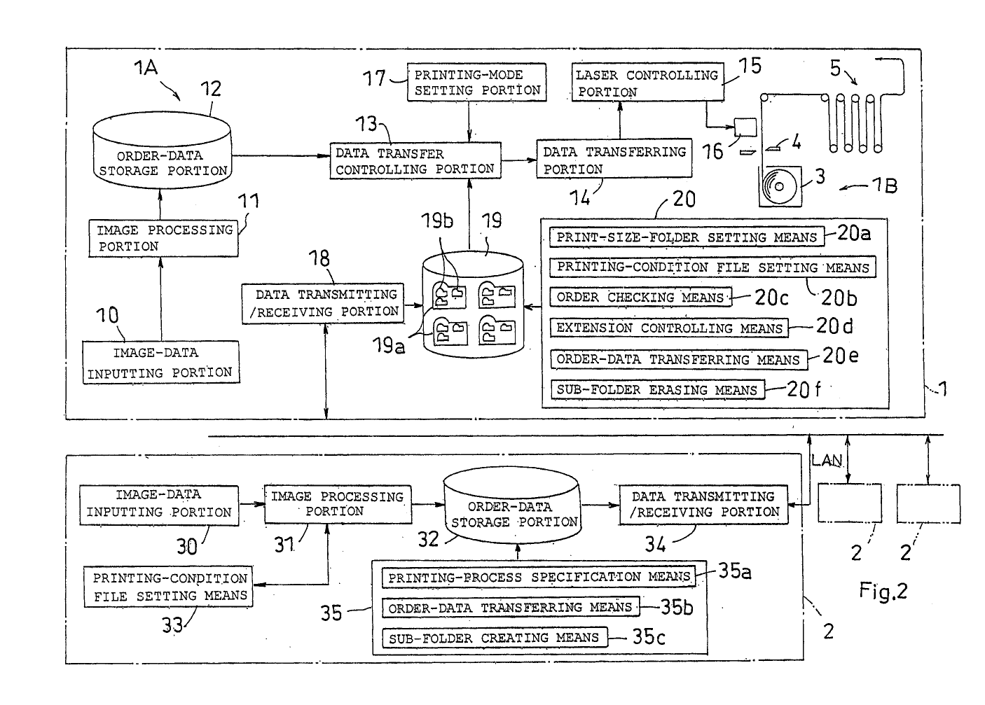

Next, with reference to a block diagram of FIG. 2, there will be described main functions of the photograph processing system illustrated in FIG. 1 according to a first embodiment. First, main functions of the photograph-print creating device 1 will be described. An image-data inputting portion 10 has the function of acquiring digital image data from developed photograph films or various types of storage mediums. An image processing portion 11 has the function of performing predetermined image processing on input image data, wherein correction parameters are set for respective image data, as previously described. An order-data storing portion 12 is constituted by a suitable storage device and stores order data on an order basis. Image data and correction parameters are stored therein. Here, the term “an order” generally means to-be-processed data in a single photograph film or a single storage medium. However, the concept of “a single order” may be properly set by operators of a photograph shops.

When order data is processed to create photograph prints, the data is transferred to a laser engine 16 through a data transfer controlling portion 13 and a data transferring portion 14.

While image data acquired directly by the photograph-print creating device 1 itself is stored in the order-data storing portion 12, photograph prints may be created from image data acquired through the LAN. Namely, in the photograph-print creating device 1, there is provided a printing-mode setting portion 17 for setting a printing mode during creating photograph prints. When a first mode is set, photograph processes can be performed on image data acquired through the image-data inputting portion 10. When a second mode is set, photograph processes can be performed on image data acquired through the LAN. Accordingly, the data transfer controlling portion 13 has the function of controlling the data path depending on which order data should be processed.

Image data acquired through the LAN is received by a data transmitting/receiving portion 18 and then is stored in a lower hierarchy folder set in a predetermined directory in a folder which is referred to as a hot folder 19. The hot folder 19 is constituted by a large-capacity storage device such as a hard disk. Print-size folders 19a (corresponding to first folders) for respective print sizes are set in the hot folder 19 and, further, a plurality of sub folders 19b (corresponding to second folders) are set in the respective print-size folders 19a. The sub folders 19b are set on an order-by-order basis, and each single sub folder 19b stores image data of a single order. The print-size folders 19a are folders set on a print-size by print-size basis, for example, 127*89, 127*102, 205*254, wherein image data stored in the 127*89 folder is used for creating photograph prints with a print size of 127 (a paper width in mm)*89 (a feeding length in mm).

When the second mode is set, order data in the print-size folders 19a is transferred to the laser engine 16 through the data transfer controlling portion 13 and the data transferring portion 14.

In the terminal processing devices 2, there are also provided an image-data inputting portion 30, an image processing portion 31 and an order-data storing portion 32 which have the same functions as those of the image-data inputting portion 10, the image processing portion 11 and the order-data storing portion 12 provided in the photograph print creating device 1. A printing-condition-file setting means 33 has the function of creating printing-condition files. The printing-condition files may be automatically created in conjunction with a predetermined operator's operation in the image processing portion 31 or may be directly created by operator's manual inputting. Order data stored in the order-data storing portion 32 is transmitted to the LAN through a data transmitting/receiving portion 34 and then is received by the data transmitting/receiving portion 18 in the photograph-print creating device 1.

In the terminal processing devices 2, there is installed hot-folder addressing software 35 which is software used for generating commands for performing photograph-print creating processes, from the terminal processing devices 2 to the photograph-print creating device 1. Major functions thereof will be described. A printing-process commanding means 35a generates commands for performing printing processes on order data stored in the order-data storing portion 32. Commands for printing processes may be generated on an order-by-order basis.

An order-data transferring means 35b has the function of transferring order data (image data) relating to the order specified by the printing-process commanding means 35a, to the photograph-print creating device 1 through the LAN. A sub-folder creating means 35c has the function of creating sub folders 19b in print-size folders 19a. In the newly created sub folders 19b, transferred order data is stored. In cases where there are plural orders, sub folders 19a are created in accordance with the number of orders. When sub folders 19b are created, folder names are automatically given thereto, which is one of the functions of the sub-folder creating means 35c (corresponding to a second folder creating means). Each file name includes an identification number for identifying the order and an extension which will be described later.

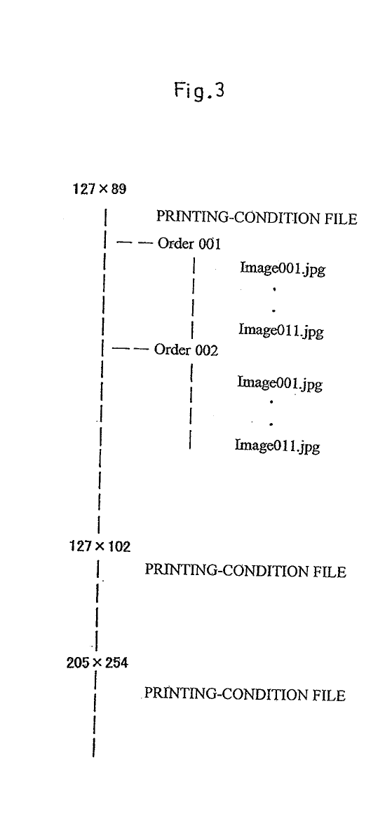

Next, there will be described functions of hot-folder addressing software 20 installed in the photograph-print creating device 1. A print-size-folder setting means 20a (corresponding to a first folder creating means) sets print-size folders 19a in the hot folder 19. FIG. 3 exemplifies, as print-size folders 19a, three folders 127*89, 127*102 and 205*254. The folders may be set through operator's manual operations or may be automatically set by automatically recognizing current processable print sizes. For example, paper magazines 3, which will be described later, hold information about the print sizes and the surface qualities of photograph photo-sensitive materials mounted therein and, by reading the information with a sensor, print-size folders 19a can be automatically created.

FIG. 3 illustrates the states of sub folders 19b set in print-size folders 19a. There are exemplified Order001 and Order002, as sub folders 19b. In the respective sub folders 19b, image data (image files) of a single order is stored. The creation of such sub folders 19b is performed on the basis of the function of the sub-folder creating means 35c which has been previously described.

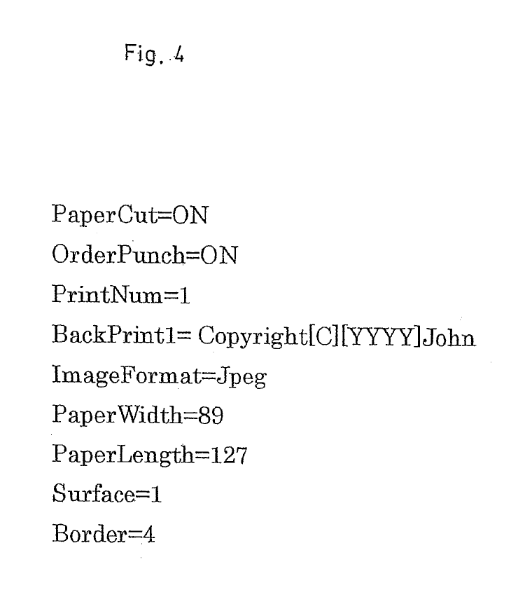

The printing-condition-file setting means 20b has the function of setting first printing-condition files in the respective print-size folders 19a. The files can be set through operator's manual operations, for example. FIG. 4 illustrates an exemplary first printing-condition file. This file includes text data describing conditions of a printing process. For example, it describes the number of prints, the presence or absence of a border and the like. The first printing-condition files are stored at the same hierarchy level as the sub folders 19b, and image data stored in the respective sub folders 19b is subjected to printing processes, on the basis of the common first printing-condition files. Namely, it is not necessary to set printing-condition files for respective sub folders 19b (orders), which can reduce the operator's operating time.

An order checking means 20c has the function of checking whether or not a new order is stored in the hot folder 19. More specifically, it checks whether or not the orders stored in sub folders 19b are new orders on the basis of the extensions of the folder names attached to the sub folders 19b. The order checking means 20c polls (monitors) the folders, at regular time intervals, in order to check whether or not there are orders to be subjected to printing processes.

An extension controlling means 20d controls the extensions of the folder names attached to sub folders 19b. This will be described later. When it has been determined that there is a new order in the hot folder 19, an order-data transferring means 20e transfers the image data stored in the sub folder 19b to cause it to be subjected to a photograph-print creating process. A sub-folder erasing means 20f erases a sub folder 19b with a proper timing, when the image data stored in the sub folder 19b and the first printing-condition file have been transferred and printing process have been performed thereon. The timing of erasure may be just after the execution of the printing processes or after the elapse of a predetermined time. This can prevent overloads on the storage capacity of the hot folder 19 (hard disk).

Image data transferred through the data transferring portion 14 is transferred to a laser controlling portion 15 and then is transferred to the laser engine 16 in synchronization with the transfer speed of a photograph photo-sensitive material.

A paper magazine 3 housing a photograph photo-sensitive material in the form of roll is detachably mounted to the printer processor 1B. The photograph photo-sensitive material is drawn from the paper magazine 3 and is cut into a predetermined print size through a paper cutter 4. The photograph photo-sensitive material is transferred at a predetermined speed along a transfer path and, during the transferring, the laser exposure 16 applies light exposure to the photograph photo-sensitive material in a scanning manner, on the basis of image data. The photograph photo-sensitive material having images printed thereon through light exposure is subjected to developing processes in the developing processing portion 5, then subjected to a drying process in the drying processing portion and then is discharged as finished photograph prints to the outside of the device.

Although there is illustrated, in the figure, only a single paper magazine 3, it is possible to mount plural paper magazines 3 housing photograph photo-sensitive materials with different sizes. In such a case, print-size folders 19a may be automatically created in accordance with actually mounted paper magazines 3.

Now, there will be described the extensions of sub folders 19 created in print-size folders 19a. Four types of extensions N, R, C, E are set therein. The extension N is an extension indicating that the sub folder 19b is being created. When a new sub folder 19b is created on the basis of the function of the sub-folder creating means 35c in the terminal processing devices 2, “N” is attached thereto as an extension. In the sub folder 19b, order data transferred from the terminal processing devices 2 is stored. When the storage of order data has been completed, a completion signal is transmitted to the extension controlling means 20d. On receiving the completion signal, the extension-controlling means 20d changes the extension from “N” to “R”. Since the extension is changed to “R”, the order data in the sub folder 19b can be determined to be data relating to a new order.

When the order data in the sub folder 19b has been transferred to be subjected to printing processes, the extension thereof is changed from “R” to “C” in order to indicate that printing processes thereon have been completed. For example, when all the data has been transferred to the laser controlling portion 15, it can be determined that the printing process on the data has been completed. The extension “E” is an extension indicating that some errors have occurred. For example, such errors include failure of data transfer, interruption of the creation of photograph prints due to a paper jam of the photograph photo-sensitive material being drawn from the paper magazine 3 during the transferring thereof. When such malfunctions have been resolved, the extension is changed from “E” to, for example, “R”, which enables restarting the printing process.

### [Procedure Until the Creation of Sub Folders]

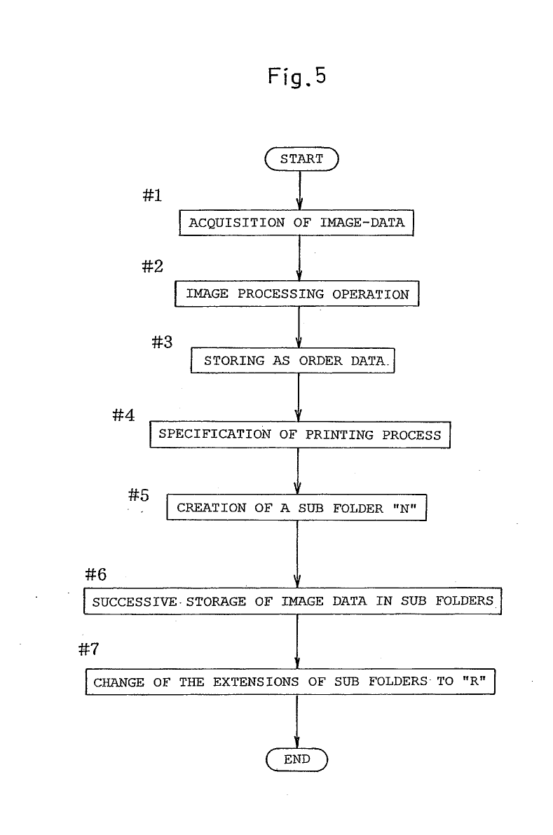

Next, the general procedure until the creation of sub folders 19b will be described, with reference to a flow chart of FIG. 5. An operator of a terminal processing device 2 acquires image data to be subjected to a photograph-print creating process, from the image-data inputting portion 30 (#1). Next, the operator performs image processing operations on the input image data (#2). The acquired image data is stored in the order-data storing portion 32, as order data (#3).

When the image data stored in the order-data storing portion 32 is to be subjected to a printing process, the hot-folder addressing software 35 is activated to generate a command for a printing process (#4). The operator can arbitrarily determine the timing of generating such a command for a printing process, after the order data has been stored. The operator can generate a command for printing processes for plural orders, instead of for only a single order. When a command for a printing process is generated, the photograph-print creating device 1 connected to the LAN is also specified. Since the photograph-print creating device 1 can be specified in advance as a usually-used printer, similarly to cases of printing documents with a personal computer, the specified photograph-print creating device 1 is usually used for performing printing processes.

When a command for a printing process is generated, a new sub folder 19b is created in a print-size folder 19a in the photograph-print creating device 1 (#5). Since print-size folders 19a are set on a print-size by print-size basis, the new sub folder 19b is created in the folder 19a for the pint size relating to the command for a printing process. A folder name is automatically attached to the sub folder 19b and also an extension of “N” is attached thereto. Image data of a single order is successively transferred from the terminal processing device 2 to the newly-created sub folder 19b and stored therein (#6). When the transfer of the image data has been completed, the extension of the sub folder 19b is changed to “R”. At this time, a printing process can be performed thereon anytime. When the command for a printing process was generated for plural orders at the step #4, the same number of sub folders 19 b are created.

### [The Procedure of Printing Processes]

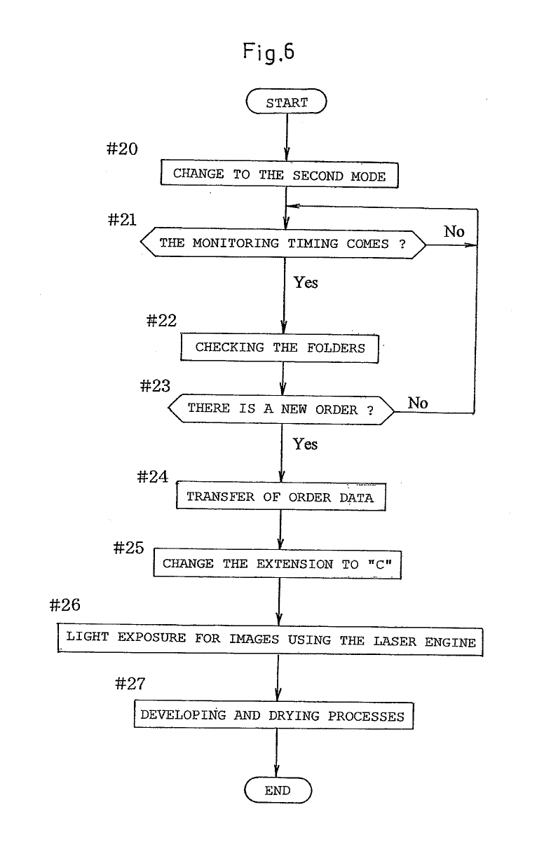

Next, with reference to a flow chart of FIG. 6, there will be described the procedure of a printing process, on the basis of the functions of the hot-folder addressing software 20. First, the printing mode is set to the second mode (#20). Since the second mode is set, photograph processes can be performed on order data transmitted through the LAN. Next, it is determined whether or not the timing of monitoring of the contents of folders comes (#21). Namely, the order checking means 20c monitors the folders at regular time intervals and, on the basis of the function, the contents of the respective print-size folders 19a are checked (#22). It is checked whether or not there are sub folders 19b with an extension of “R” in the respective folders 19a (#23). On the basis of the types of the extensions, it can be determined whether or not there are new orders. When there is no new order, the monitoring mode is continued (#21).

When there is a new order, the image data stored in the sub folder 19b and the printing-condition data stored in the print-size folder 19a that stores the sub folder 19b are transferred to the laser controlling portion 15 (#24). When the transfer of the order data has been completed, the extension of the sub folder 19b is changed to “C”, on the basis of the function of the extension controlling means 20d (#25). Since the extension is changed to “C”, it can be determined that the order has been subjected to printing processes. The laser engine 16 applies light exposure to the photograph photo-sensitive material for printing images thereon, using the transferred image data (#26). The photograph photo-sensitive material having images printed thereon with light exposure is subjected to developing processes and a drying process and then is discharged as photograph prints to the outside of the device (#27).

### [Another Exemplary Structure of Folders]

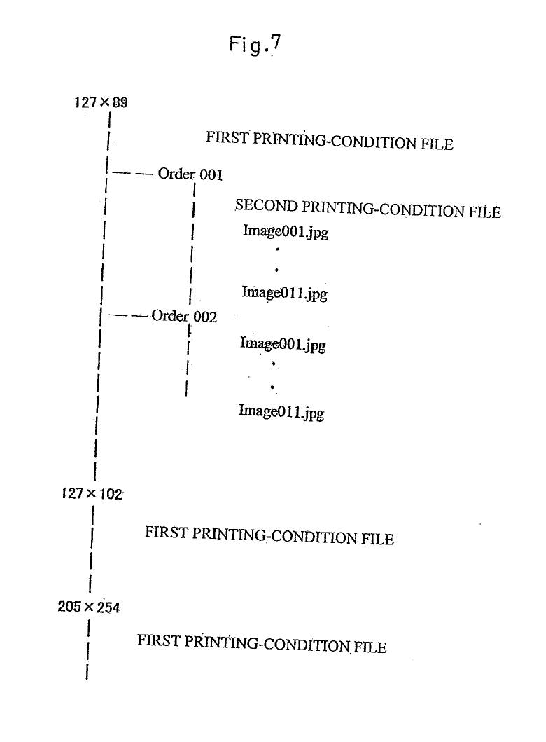

Next, with reference to FIG. 7, another exemplary structure of folders will be described. FIG. 3 exemplifies a case where printing-condition files are stored at the same hierarchy level as the sub folders 19b. Namely, the image data stored in the respective sub folders 19b is subjected to printing processes, on the basis of the first printing-condition files. In this case, all the orders stored in the print-size folders 19a are processed according to the first printing-condition files. However, there may be a need for performing a printing process under a different condition from the first printing-condition files. For example, although in the first printing-condition files the number of prints is set to one for all frames, there may be a need for changing the number of prints for certain frames. In this case, it is necessary to particularly set the printing condition.

Therefore, it is possible to set a second printing-condition file specific to the order, as required. In FIG. 7, a printing-condition file is set in a sub folder “Order001”. Accordingly, the “Order001” is subjected to printing processes according to the second printing-condition file while the other folder “Order002” is subjected to printing processes according to the first printing-condition file. This enables setting printing-condition files appropriate to the circumstances of respective orders, while reducing the effort to create printing-condition files.

### Other Examples of the First Embodiment

While in the first embodiment there has been described an exemplary folder hierarchy structure for processing orders relating to requests from the terminal processing devices 2, the present invention is not limited thereto, and image data input directly to the photograph-print creating device 1 can be similarly processed. Namely, the present invention may be applied to the folder hierarchy structure for storing order data in the order-data storing portion 12.

While in the first embodiment there has been described a structure for storing data in the sub folders 19b on an order basis, orders may be set on a purchase-order basis or on a process basis. In the case of a process basis, for example, if a single purchase order for different print sizes is received, data may be stored in respective sub folders 19b on a size-by-size basis. In this case, this purchase order can be made distinguishable from the other purchase orders, for example, by attaching a sub number to the order number.

While in the first embodiment there have been described print-size folders 19a as first folders, folders may be created on the basis of other conditions such as the paper surface quality, the presence or absence of a border (corresponding to print information), instead of on the basis of the print size.

While in the first embodiment the sub-folder creating means 35c is set as a function of the terminal processing devices 2, it may be set as a function of the photograph-print creating device 1. Also, the functions of the extension controlling means 20d may be provided in the terminal processing devices 2.

While in the first embodiment the sub folders 19b (second folders) are structured to be created in the print-size folders 19a (first folder), the present invention is not limited to this embodiment, and sub folders 19b may be created at the same hierarchy level as print-size folders 19a. The aforementioned other examples may be also applied to the following embodiments.

### Second Embodiment

### [Order Monitoring System Function]

### [Functional Block Diagram]

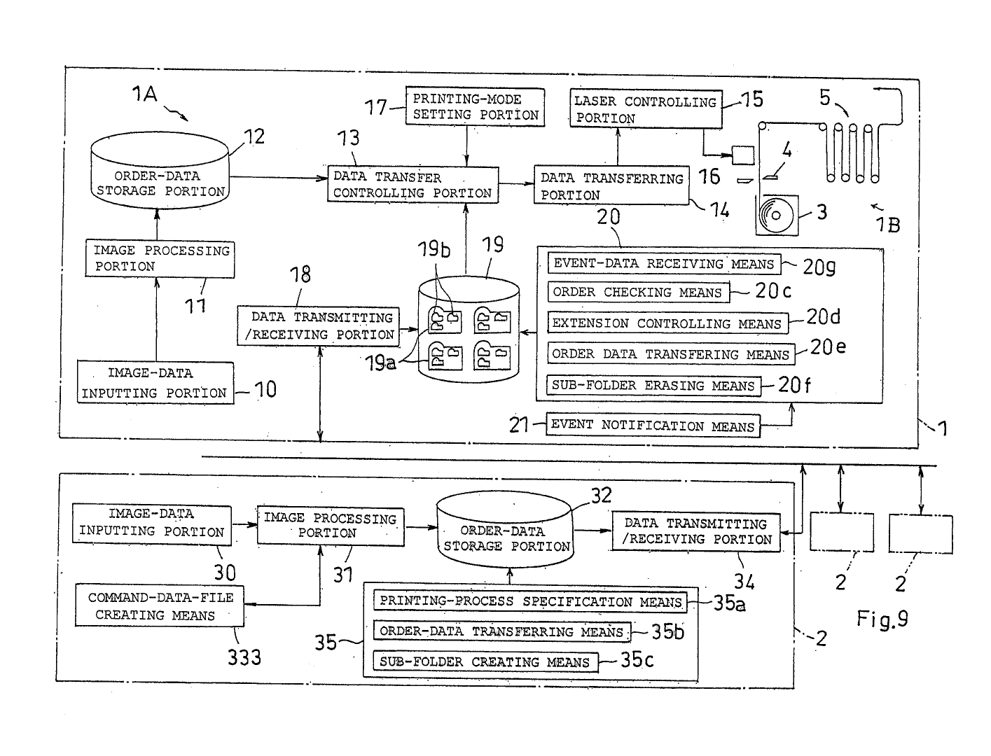

With reference to a block diagram of FIG. 9, there will be described main functions of a second embodiment of the photograph processing device illustrated in FIG. 1. First, main functions of the photograph-print creating device 1 will be described. An image-data inputting portion 10, an image processing portion 11, an order-data storing portion 12, a data transfer controlling portion 13, a data transferring portion 14, a laser engine 16 and a printing-mode setting portion 17 have the same functions as those of the first embodiment. In the following second to fifth embodiments, components designated by the same reference characters as those of the first embodiment have the same functions as those of the first embodiment and description thereof may be omitted.

Image data transmitted through the LAN is received by a data transmitting/receiving portion 18 and is stored in a hot folder 19. The received data is order data consisting of image data and command data. The command data is data describing the contents of processes for the image data and is stored therein in the form of a text file, on an order-by-order basis. Plural sub folders 19b are created in the hot folder 19. The sub folders 19b are created on an order-by-order basis and, each single sub folder 19 stores image data of a single order and command data. When a second mode is set, order data in the hot folder 19 is transferred to the laser engine 16 through the data transfer controlling portion 13 and the data transferring portion 14. The sub folders 19b correspond to the second folders in the aforementioned first embodiment and are stored in print-size folders 19a (first folders).

A command-data-file creating portion 333 in each terminal processing device 2 has the function of creating command data files. The command data may be automatically created in conjunction with operator's setting operations in the image processing portion 31 or may be created through operator's manual inputting.

Hot-folder addressing software 35 installed in each terminal processing device 2 has the same functions as that of the first embodiment and description thereof is omitted herein.

Next, there will be described the functions of hot-folder addressing software 20 installed in the photograph-print creating device 1. An event-data receiving means 20g receives event data from an event notification means 21. Such event data is data which, in the event of change of a folder name, providing a notification of the fact. It is possible to utilize functions of an OS (Operating System), as the functions of the event notification means 21. An order checking means 20c has the function of checking whether or not there is stored a new order in the hot folder 19, when the event-data receiving means 20g has received event data.

An extension controlling means 20d controls the extensions of the folder names attached to sub folders 19b. This will be described later. When it has been determined that there is a new order in the hot folder 19, an order-data transferring means 20e transfers the image data stored in the sub folder 19b to cause it to be subjected to a photograph-print creating process. A sub-folder erasing means 20f erases a sub folder 19b with a proper timing, when the order data stored in the sub folder 19b has been transferred and printing process has been performed thereon. The timing of erasure may be just after the execution of the printing processes or after the elapse of a predetermined time.

A printer processor 1B has the same functions as that of the first embodiment.

Next, there will be described the function of checking whether or not there are new orders in the hot folder 19. Conventionally, in order to check whether or not there are new orders in the hot folder 19, the content of the hot folder 19 has been checked (polled) at regular time intervals. For example, the content of the hot folder 19 has been monitored at several-second intervals, which has caused degradation of the performance of the entire photograph processing system. Therefore, a monitoring system according to the present invention checks the content of the hot folder 19 only in the event of the reception of event data, rather than monitoring it at regular time intervals, which can reduce vain checking processes, thereby improving the performance.

Now, there will be described the extensions of sub folders 19b created in the hot folders 19. Four types of extensions N (corresponding to a first extension), R, C, E are set therein. The extension N is an extension indicating that the sub folder 19b is being created. When a new sub folder 19b is created in the hot folder 19 on the basis of the function of the sub-folder creating means 35c in the terminal processing devices 2, “N” is attached thereto as an extension. In the sub folder 19b, order data transferred from the terminal processing devices 2 is stored. When the storage of order data has been completed, a completion signal is transmitted to the extension controlling means 20d. On receiving the completion signal, the extension-controlling means 20d changes the extension from “N” to “R” (corresponding to a second extension). Since the extension is changed to “R”, the order data in the sub folder 19b can be determined to be data relating to a new order.

When the order data in the sub folder 19b has been transferred to be subjected to printing processes, the extension thereof is changed from “R” to “C” in order to indicate that printing processes thereon have been completed. For example, when all the data has been transferred to the laser controlling portion 15, it can be determined that the printing process on the data has been completed. The extension “E” is an extension indicating that some errors have occurred. For example, such errors include failure of data transfer, interruption of the creation of photograph prints due to a paper jam of the photograph photo-sensitive material being drawn from the paper magazine 3 during the transferring thereof, occurrences of improper commands in the transmitted command data. When such malfunctions have been resolved, the extension is changed from “E” to, for example, “R”, which enables restarting the printing process.

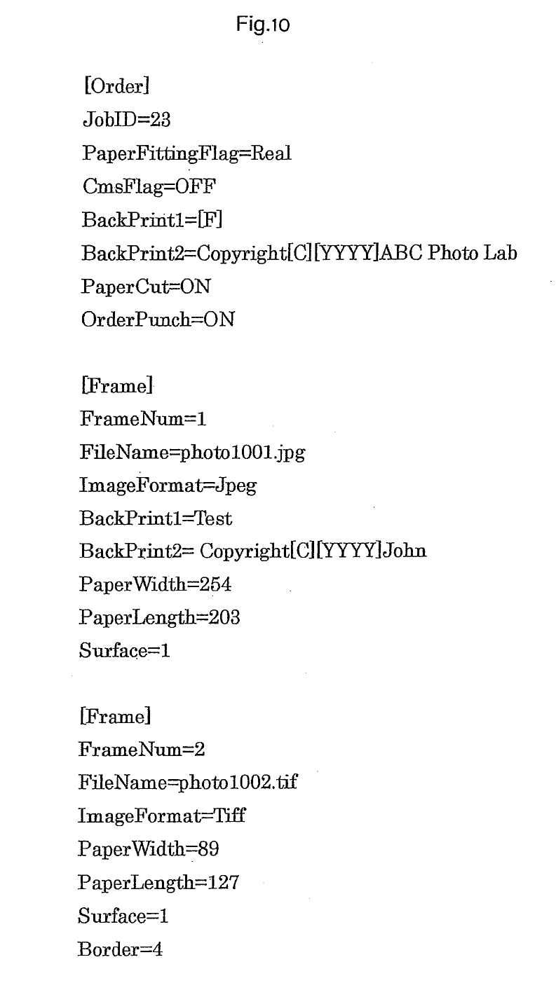

In the sub folders 19b created in the hot folder 19, image-data files of a single order and a command data file are stored. FIG. 10 illustrates exemplary command data which is constituted by text data. The command data includes description of the file names, the image file formats, the frame numbers, the back-prints (data to be printed on the back surface of the photograph print), the photograph print sizes for respective image data included in the order. On the basis of the command data and respective image data, photograph-print creating processes can be performed. A single command data file is provided for each single order.

### [Procedure Until the Creation of Sub Folders]

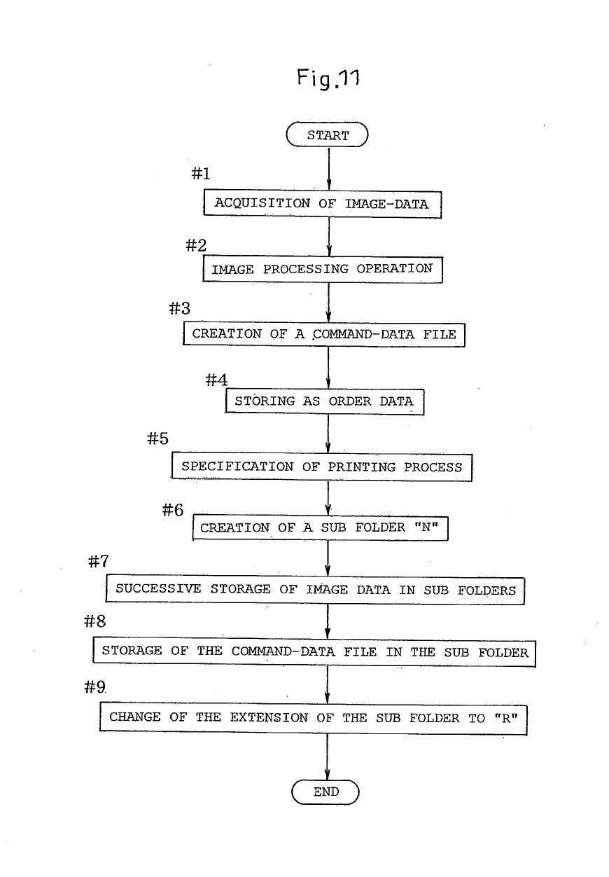

Next, the general procedure until the creation of sub folders 19b will be described, with reference to a flow chart of FIG. 11. An operator of a terminal processing device 2 acquires image data to be subjected to a photograph-print creating process, from the image-data inputting portion 30 (#1). Next, the operator performs image processing operations on the input image data (#2). Further, a command data file is created (#3). The acquired image data and command data are stored in the order-data storing portion 32, as order data (#4).

When the image data stored in the order-data storing portion 32 is to be subjected to a printing process, the hot-folder addressing software 35 is activated to generate a command for a printing process (#5). The operator can arbitrarily determine the timing of generating such a command for a printing process, after the order data has been stored. The operator can generate a command for printing processes for plural orders, instead of for only a single order. When a command for a printing process is generated, the photograph-print creating device 1 connected to the LAN is also specified. Since the photograph-print creating device 1 can be specified in advance as a usually-used printer, similarly to cases of printing documents with a personal computer, the specified photograph-print creating device 1 is usually used for performing printing processes.

When a command for a printing process is generated, a new sub folder 19b is created in a hot folder 19 in the photograph-print creating device 1 (#6). A folder name is automatically attached to the sub folder 19b and also an extension of “N” is attached thereto. Image data of a single order is successively transferred from the terminal processing device 2 to the newly-created sub folder 19b and stored therein (#7). When the transfer of the image data has been completed, the command data file is transferred thereto and is stored in the same sub folder 19b (#8). Thus, the transfer of the order data has been completed and, then the extension of the sub folder 19b is changed to “R”. At this time, a printing process can be performed thereon anytime. When the command for a printing process was generated for plural orders at the step #5, the same number of sub folders 19b are created.

### [The Procedure of Printing Processes]

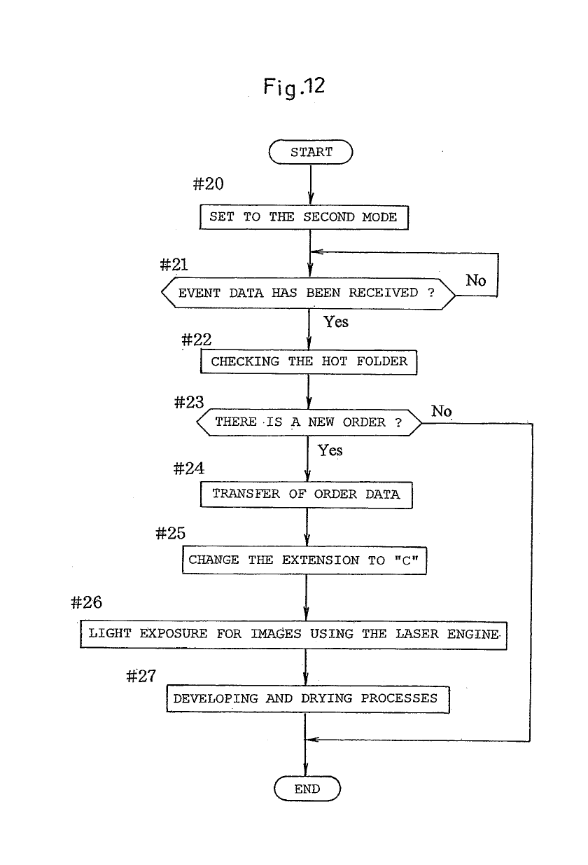

Next, with reference to a flow chart of FIG. 12, there will be described the procedure of a printing process, on the basis of the functions of the hot-folder addressing software 20. First, the printing mode is set to the second mode (#20). Since the second mode is set, photograph processes can be performed on order data transmitted through the LAN. Next, it is determined whether or not the event-data receiving means 20g has received event data (#21) and, if it has received, the content of the hot folder 19 is checked on the basis of the function of the order checking means 20c (#22). It is checked whether or not there are sub folders 19b with an extension of “R” in the hot folder 19 (#23). On the basis of the types of the extensions, it can be determined whether or not there are new orders.

When there is a new order, the order data stored in the sub folder 19b is transferred to the laser controlling portion 15 (#24). When the transfer of the order data has been completed, the extension of the sub folder 19b is changed to “C”, on the basis of the function of the extension controlling means 20d (#25). Since the extension is changed to “C”, it can be determined that the order has been subjected to printing processes. The laser engine 16 applies light exposure to the photograph photo-sensitive material for printing images thereon, using the transferred image data (#26). The photograph photo-sensitive material having images printed thereon with light exposure is subjected to developing processes and a drying process and than is discharged as photograph prints to the outside of the device (#27).

### Other Examples of the Second Embodiment

In the second embodiment, order data is constituted by image-data files and a command data file. The image data may be original image data input from the image-data inputting portion 30 or may be corrected image data which has been subjected to a correcting process in the image processing portion 31. Further, the command data may include various types of correction parameters set with the image processing portion 31. In this case, printing image data is created on the basis of the original image data and the correction parameters and then is transferred to the laser engine 16, in the photograph-print creating device 1.

While in the second embodiment there has been exemplified cases where order data is transferred to the laser engine 16 (the image light-exposure device), order data is transferred to a medium writing device in cases where image data is written into storage mediums (an example of the photograph process). Also, data may be transferred to both the laser engine 16 and the medium writing device.

While in the second embodiment there are four types of extensions, the present invention is not limited thereto and the number of types of extensions may be further increased. Also, the number of characters or the like constituting the extensions may be properly selected. Further, the portions of folder names other than the extensions may be changed to enable determination of the states of the orders.

While in the second embodiment the content of the hot folder 19 is checked in the event of the reception of event data, by adding, to such event data, data indicative of the type of the extension, it is possible to enable monitoring the content of the hot folder 19 with higher efficiency. Namely, the hot folder 19 can be checked, only when it is determined, through an analysis of event data, that the extension has been changed to “C”. This enables monitoring the hot folder 19 with higher efficiency.

While in the second embodiment the sub-folder creating means 35c is set as a function of the terminal processing devices 2, it may be set as a function of the photograph-print creating device 1. Further, the functions of the extension controlling means 20d may be provided in the terminal processing devices 2.

While, in the second embodiment, sub folders 19b have been described as being created in print-size folders 19a (first folder), the present invention is not limited thereto and it is necessary only that sub folders 19b are created in the hot folder 19 and the sub-folder creating means 35c may be configured to create sub folders 19b at the same hierarchy level as the print-size folders 19a (first folders).

### Third Embodiment

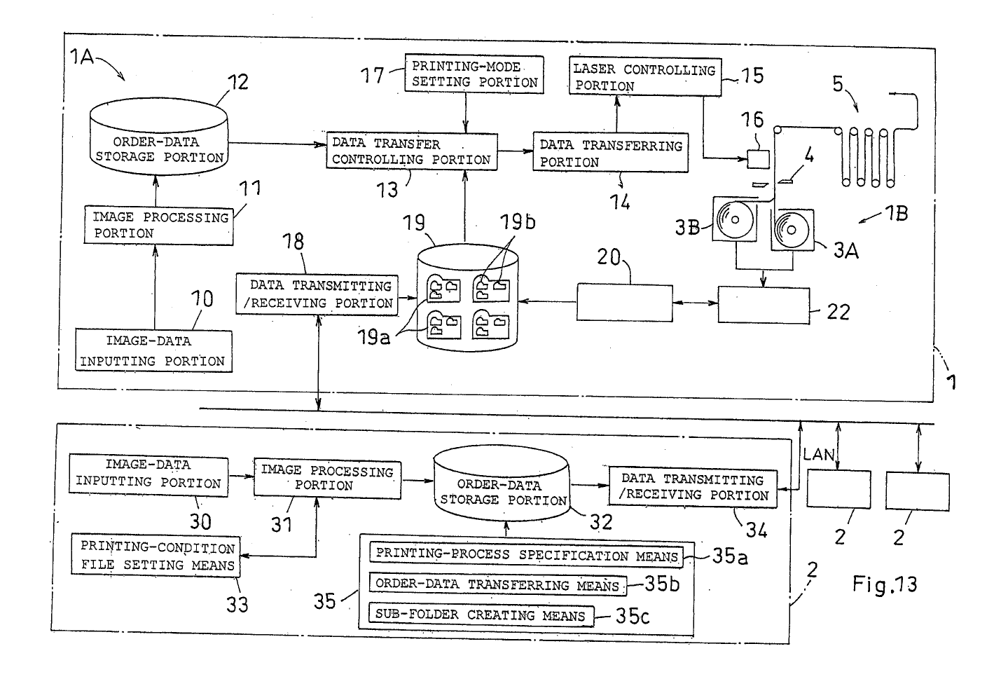

With reference to a block diagram of FIG. 13, there will be described main functions of a third embodiment of the photograph processing device illustrated in FIG. 1. First, main functions of the photograph-print creating device 1 will be described. An image-data inputting portion 10, an image processing portion 11, an order-data storing portion 12, a data transfer controlling portion 13, a data transferring portion 14, a laser engine 16 and a printing-mode setting portion 17 have the same functions as those of the first embodiment. Further, the contents of image forming processes are also the same as those of the first embodiment.

A printer processor 1B has the same functions as that of the first embodiment.

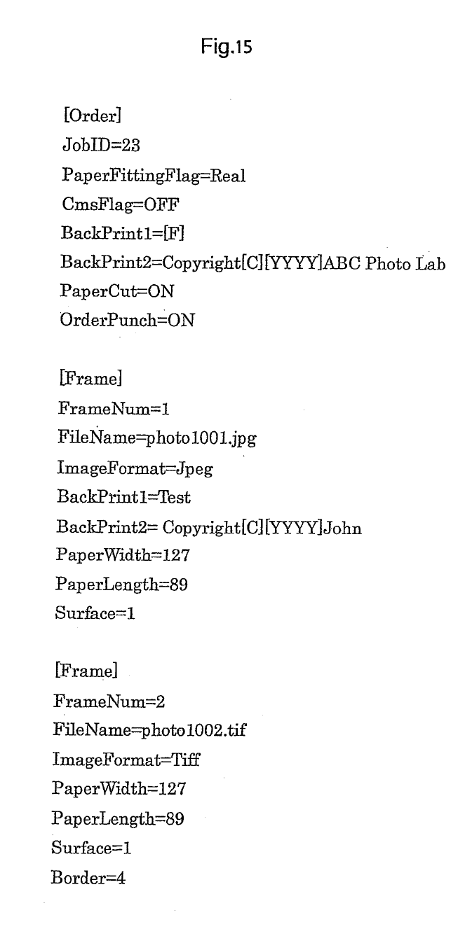

Further, respective components of the terminal processing devices 2 have the same functions as those of the first embodiment. Printing-condition files include text data describing the conditions of printing processes (see FIG. 15). For example, the conditions include the number of prints, the presence or absence of a border.

Hot-folder addressing software 35 installed in the terminal processing devices 2 has the same functions as that of the first embodiment.

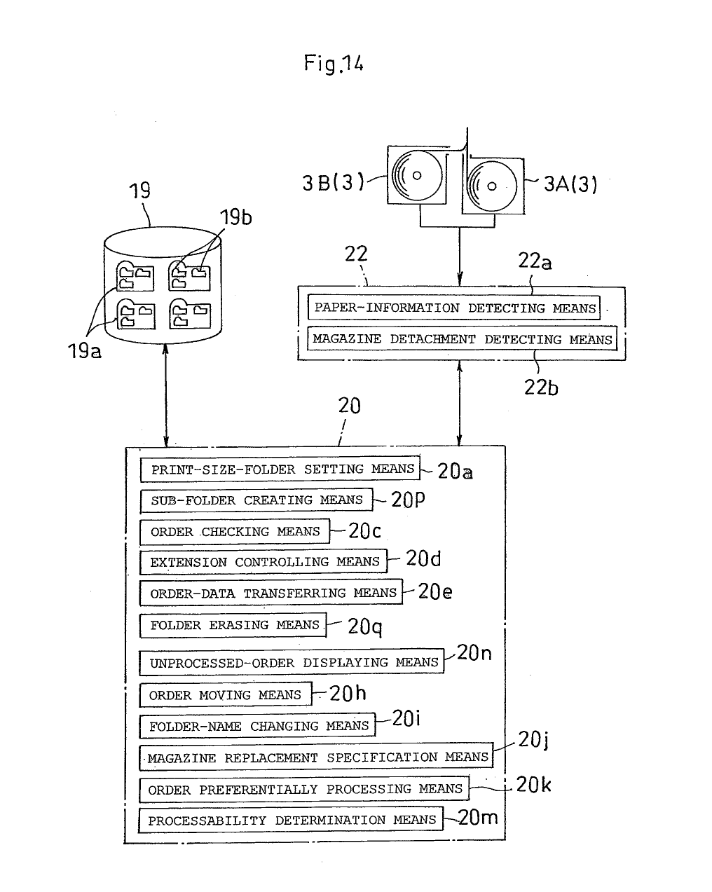

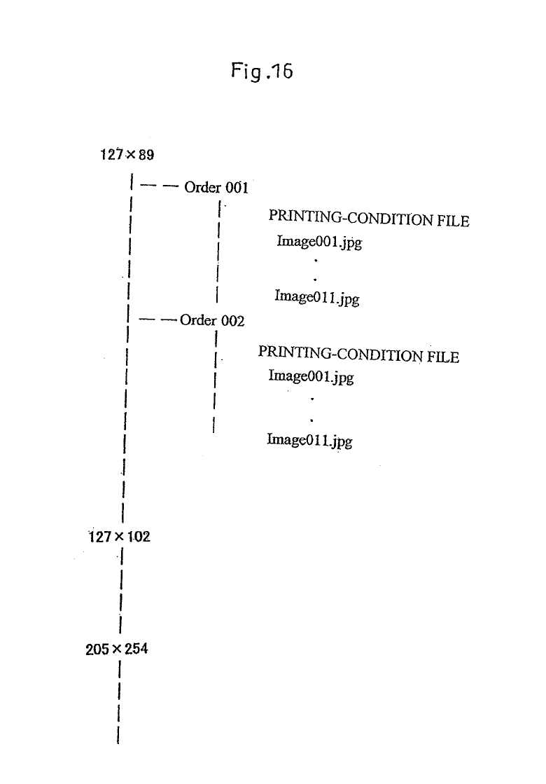

Next, there will be described functions of hot-folder addressing software 20 installed in the photograph-print creating device 1. A print-size-folder setting means 20a (corresponding to a first folder creating means) sets print-size folders 19a in the hot folder 19. FIG. 16 exemplifies, as print-size folders 19a, three folders 127*89, 127*102 and 205*254. Paper with a width of 127 mm can be applied to both the pint sizes 127*89 and 127*102, by using a single paper magazine 3. Accordingly, the number of folders which can be set for a single paper magazine 3 is not limited to one and may be two or more. Although the setting of folders may be performed through operator's manual operations, in the present invention, folders are automatically set by automatically recognizing the current processable print sizes. Hereinafter, this point will be described with reference to FIG. 14.

First, two paper magazines 3 (designated by 3A and 3B) are detachably mounted to the photograph-print creating device 2. The number of paper magazines 3 which can be mounted thereto can be properly set. There is provided a magazine-information detecting portion 22 which detects information about the paper magazines 3. The magazine-information detecting portion 22a has the function of detecting information about the mounted paper. The paper information corresponds to information about the width dimension of the housed paper, the surface quality of the paper (mat or gloss, etc.), the manufacturer name and the like. The paper information can be attached to the paper magazines 3 by attaching bar code labels to the outer surfaces of the paper magazines 3 or forming, therethrough, bit holes indicating their paper information.

The magazine attachment/detachment detecting means 22b has the function of detecting the detachment of the paper magazines 3 and is capable of detecting the disengagement of any of the paper magazines 3 from the device. For example, the magazine attachment/detachment detecting means 22b can perform detections, on the basis of outputs from a switch or a sensor which operates in conjunction with the detachment and the movement of the paper magazines 3. The hot-folder addressing software 20 performs various types of processes, on the basis of the result of detection by the magazine-information detecting portion 22. As one of the processes, the print-size-folder setting means 20a creates print-size folders 19a, using the result of detection by the paper-information detecting means 21a. For example, when paper with a width of 127 mm housed therein is detected, the print-size-folder setting means 20a creates a folder for 127*89 and a folder for 127*102, as exemplified in FIG. 16. The terms “127*89” and “127*102” designate print sizes.

FIG. 16 illustrates the states of sub folders 19b (corresponding to second folders) set in print-size folders 19a. There are exemplified Order001 and Order002, as sub folders 19b. In the respective sub folders 19b, image data (image files) of a single order is stored. The creation of such sub folders 19b is performed on the basis of the function of the sub-folder creating means 35c (corresponding to a second-folder creating means) which has been previously described. However, the creation of such sub folders 19b may be performed on the basis of the functions of the sub-folder creating means 20p in the photograph-print creating device 1.

An order checking means 20c, an extension controlling means 20d, and an order-data transferring means 20e have the same functions as the order checking means 20c, the extension controlling means 20d, and the order-data transferring means 20e according to the first embodiment.

A folder erasing means 20q erases sub folders 19b with a proper timing, when the image data and the printing-condition files stored in the sub folders 19b have been transferred therefrom and subjected to printing processes. The timing of erasure may be just after the execution of the printing process or after the elapse of a predetermined time period since then. This can prevent overloads on the storage capacity of the hot folder 19 (hard disk).

The extensions of sub folders 19b created in print-size folders 19a are the same as those in the first embodiment and description thereof is omitted herein.

### [Procedure for Replacement of Paper Magazines]

Next, there will be described the procedure for replacement of the paper magazines 3. When the paper housed in a paper magazine 3 has been consumed, it is necessary to house new paper therein, which requires temporarily disengaging the paper magazine 3 and replacing the paper. In the case where it is required that the print size being subjected to printing processes is changed, it is necessary to replace the paper magazine 3 with a paper magazine 3 housing paper with a different width size. In this case, since the print-size-folder setting means 20a creates folders for only current processible print sizes as previously described, when the paper magazine 3 has been disengaged from the device, the print-size folders 19a for this paper magazine 3 must be erased. This erasing function can be realized by the folder erasure means 20q.

However, there may be still unprocessed orders in the sub folders 19b and, if the sub folders 19b are collectively erased, such order data which has not been subjected to printing processes will be erased, thereby causing problems. In the event that the magazine attachment/detachment detecting means 22b detects the disengagement of a paper magazine 3, when there is an unprocessed order, the unprocessed-order displaying means 20n displays the fact. This enables the operator to recognize that there is still an unprocessed order. Such displaying may be realized by displaying, on a monitor screen, characters describing “There is still an unprocessed order” or by displaying, on the monitor screen, a list of unprocessed orders. Also, displaying of errors may be performed. When there is no unprocessed order, the print-size folders 19a can be erased.

There are various types of possible methods for addressing cases where there are left unprocessed orders. For example, when a paper magazine 3 with the same paper width is mounted again, namely when a paper magazine 3 is mounted after the paper therein is replaced with paper of the same type, a folder for the same print size is created and, therefore, the order data therein is not erased.

Further, a folder-name changing means 20i may change the folder names of the print-size folders 19a. This is a method for temporarily evacuating order data. In the case of changing the folder names of print-size folders 19a, the print-size folders 19a may be stored at the same directory in the hot folder 19 or may be moved to another position. This method is effective in cases of replacing the paper magazine 3 with a paper magazine 3 with a different paper width.

A magazine-replacement specification means 20j offers the function of specifying, in advance, the replacement of a paper magazine 3. Namely, the magazine-replacement specification means 20j is capable of specifying a paper magazine 3 (3A or 3B) to be removed and a paper magazine 3 to be newly mounted. In the case where a paper magazine 3 is specified, an order preferentially-processing means 20k preferentially processes orders stored in the print-size folders 19a for this paper magazine 3. For example, in the case where a paper magazine 3B is specified, even when orders are being processed with the paper magazine 3A, the printing process is switched to printing processes with the paper magazine 3B and orders are preferentially processed with the paper magazine 3B. Consequently, when the paper magazine 3B is detached, there is no unprocessed order.

When the order checking means 20c determines that there is an unprocessed order, a processability determination means 20m determines whether or not the unprocessed order can be processed with the other paper magazine 3. For example, it is assumed that the paper magazine 3A is to be removed, when printing processes for a print size of 89 mm (width)*127 mm(feeding length) are being performed with the paper magazine 3A. In this case, if the other paper magazine 3B houses paper with a width of 127 mm, the feeding length thereof can be set to 89 mm to enable continuously performing printing processes. Accordingly, by moving the order data into the print-size folder 19a based on the paper magazine 3B, printing processes can be performed on the order data. Therefore, when the processability determination means 20m determines that unprocessed order data can be processed, the order data is moved along with the sub folder 19b. This will change the relationship between the longitudinal and lateral sides of image data and, therefore, the images are subjected to rotating processes before the movement of the data.

When information about a paper magazine 3 to be newly mounted can be known in advance, the order data can be moved in consideration of the information. For example, it is assumed that paper magazines 3 with a width of 89 mm and a width of 127 mm are currently mounted. It is further assumed that the 89-mm paper magazine is to be detached and a 254-mm paper magazine 3 is to be newly mounted. When printing processes for 89*127 and printing processes for 89*254 are being performed, these order data can be processed with the currently-mounted 127 mm-paper magazine and the to-be-newly-mounted 254-mm paper magazine, respectively, and therefore the data can be moved to the print-size folders 19a prepared for these paper magazines 3. In this case, the image data is subjected to 90-degree rotating processes.

### [Procedure for Replacement of Magazines]

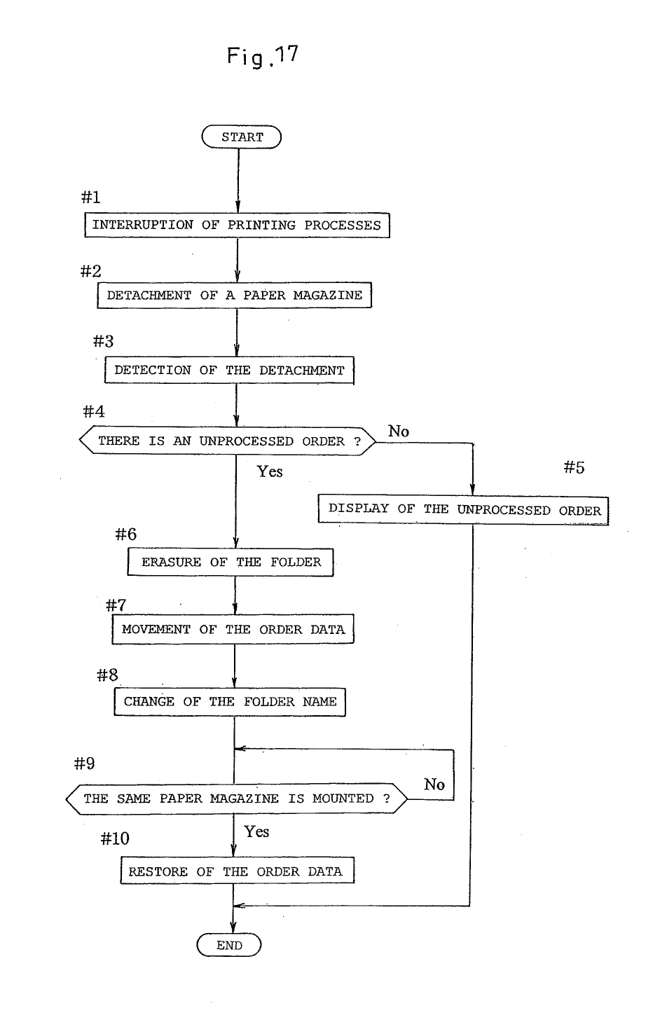

Next, with reference to a flow chart of FIG. 17, the procedure for replacement of paper magazines 3 will be described. The present invention is not limited to the following process procedure and various changes may be made thereto.

When a paper magazine 3 is to be detached, the printing process is temporarily interrupted at first (#1). Next, the paper magazine 3 is detached (#2). When the magazine attachment/detachment detecting means 21b detects the detachment of the paper magazine 3 (#3), the order checking means 20c determines whether or not there is still an unprocessed order (#4). When there is no unprocessed order, the print-size folders 19a for the paper magazine 3 are no longer necessary and therefore they are erased (#5).

When it is determined that there is still an unprocessed therein, the fact is displayed on the monitor screen (#6). Next, the order data is moved to another storage position (#7). This movement can be realized by the function of an order moving means 20h or through operator's manual operations. In this case, it is preferable that the folder name is changed to make it distinguishable from the other folders (#8). The moved order data is maintained on standby until a paper magazine 3 with the same width is mounted (#9). When the paper magazine 3 has been mounted, the moved folder is returned to the original directory and the folder name is also restored to the original name (#10). This enables processing the orders which were evacuated.

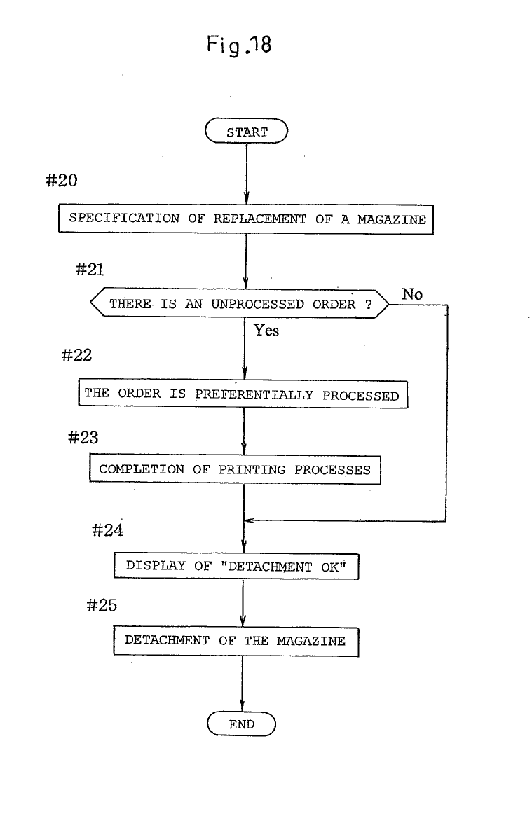

Next, with reference to a flow chart of FIG. 18, there will be described another procedure for replacement of a paper magazine 3. When a paper magazine 3 is to be replaced, the paper magazine 3 to be detached is specified (reserved) (#20). When the magazine has been specified, it is determined whether or not there is still an unprocessed order in the sub folders 19b in the print-size folders 19 set for the paper magazine 3 (#21). When there is still an unprocessed order, the order is preferentially subjected to printing processes (#22). This is for completing the processes for all order data prior to the detachment of the paper magazine 3.

When the printing processes have been completed, “detachment OK” is displayed on the monitor screen (#23 and #24). This is also performed when it has been determined that there is no unprocessed order. The operator can safely detach the paper magazine 3 by seeing the display (#25).

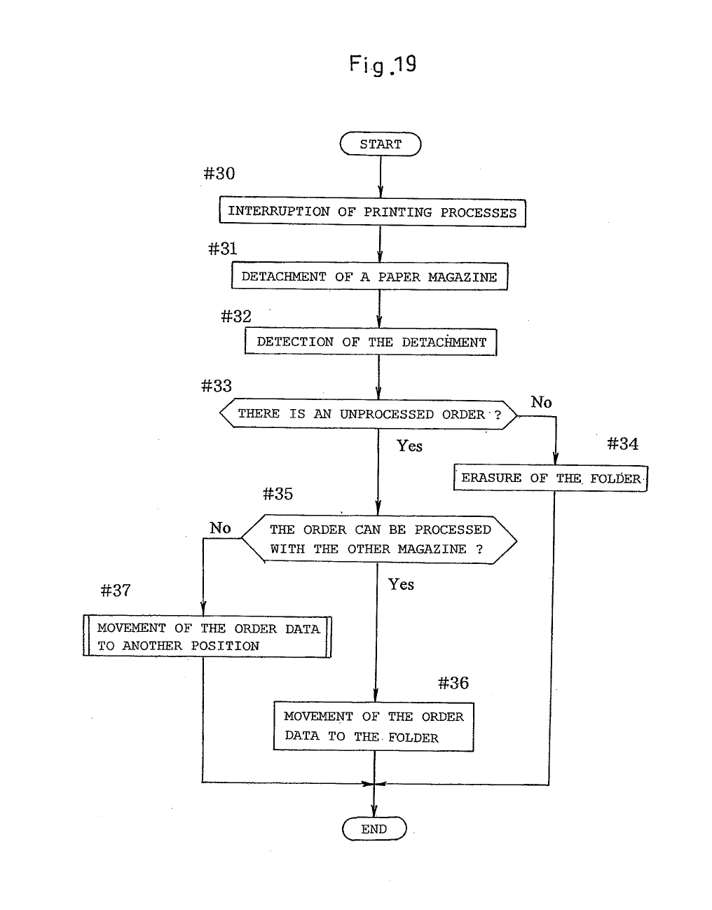

With reference to a flow chart of FIG. 19, another embodiment will be described. Steps #30 to 34 are the same as the aforementioned steps #1 to #5 in FIG. 17. When it is determined at the step #33 that there is still an unprocessed order, it is determined whether or not the unprocessed order can be processed with the other paper magazine 3 which is not detached (#35). When it can not be processed therewith, the order data is moved and evacuated to another storage position, as described with reference to FIG. 17 (#37). When it can be processed with the other paper magazine 3, the order data is moved to the print-size folder 19a for this paper magazine 3 (#36).

### Other Examples of the Third Embodiment

While unprocessed orders are displayed by displaying them on the monitor screen, the present invention is not limited thereto and they may be displayed with a lamp such as an LED or through warning with a beeper sound. Further, the combination of a visual display and a display with a beeper sound may be employed.

While, in the third embodiment, the magazine attachment/detachment detecting means 22a detects the detachment of a magazine at the timing of moving the paper magazine 3 for disengaging it from the device, the present invention is not limited thereto. For example, when there is provided a mechanism for mechanically locking the paper magazines 3 to the device, the operation of the locking mechanism cam be detected. Also, when the magazine replacement specification means 20j specifies the replacement of a magazine, this specification can be detected as the detachment of the paper magazine.

While, in the third embodiment, the magazine attachment/detachment detecting means 22b and the paper-information detecting means 22a are separately provided, the paper-information detecting means 22a may be structured to serve as the magazine attachment/detachment detecting means 22b.

While, in the third embodiment, the hot-folder addressing software 20 in the photograph-print creating device 1 and the hot-folder addressing software 35 in the terminal processing devices 2 have been described as being separated from each other, these functions may be properly provided in any of the devices. Further, these software 20, 35 may be made identical to each other and their functions may be selectively utilized. Also, these software may incorporate the function of the printing-condition-file setting means 33.

While in the third embodiment there has been described a structure for storing data in the sub folders 19b on an order basis, orders may be set on a purchase-order basis or on a process basis. In the case of a process basis, for example, if a single purchase order for different print sizes is received, data may be stored in respective sub folders 19b on a size-by-size basis. In this case, this purchase order can be made distinguishable from the other purchase orders, for example, by attaching a sub number to the order number.

While, in FIG. 16 in the third embodiment, printing-condition files are set in the respective sub folders 19b which are set on an order-by-order basis, default printing-condition files may be set in the respective print-size folders 19a at the same hierarchy level as the sub folders 19b therein and respective orders may be subjected to printing processes according to the default printing-condition files (see FIG. 3 and FIG. 7 in the first embodiment).

The paper for forming images thereon is not limited to a photograph photo-sensitive material and may be various types of paper.

### Fourth Embodiment

### [Functional Block Diagram]

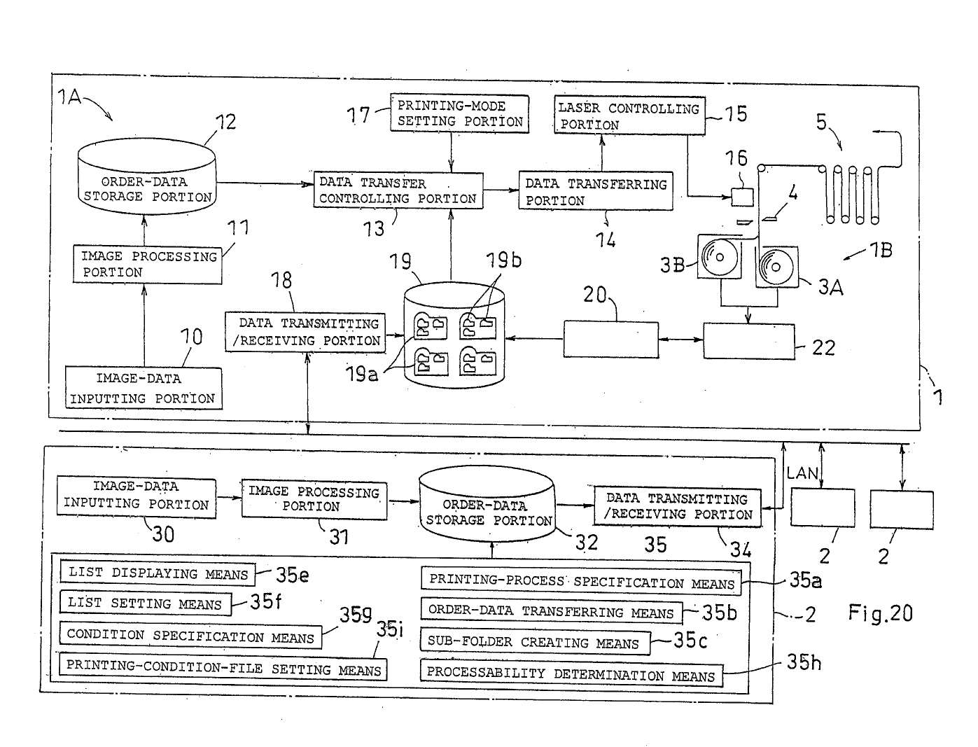

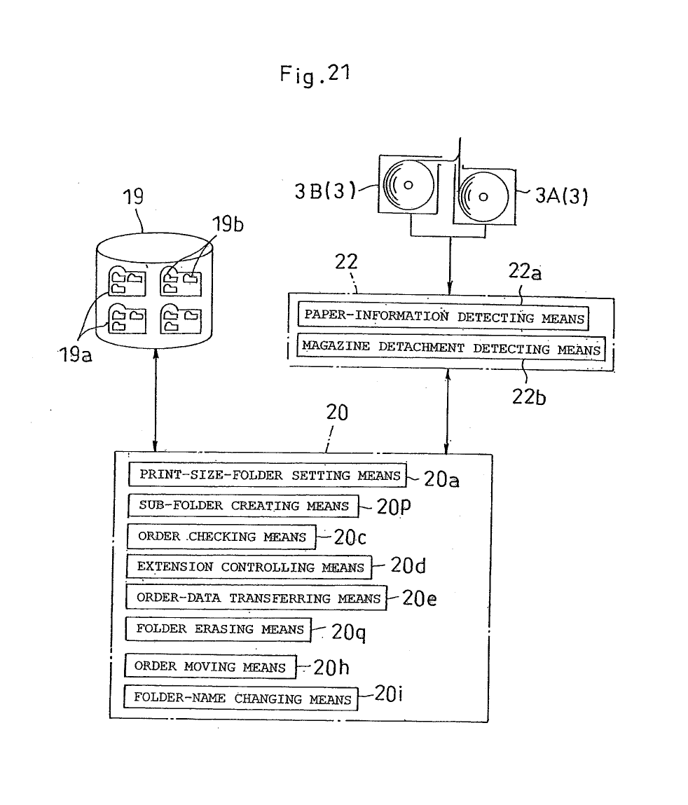

With reference to block diagrams of FIG. 20 and FIG. 21, there will be described main functions of a fourth embodiment of the printing processing device illustrated in FIG. 1. First, main functions of the photograph-print creating device illustrated in FIG. 1 will be described. An image-data inputting portion 10, an image processing portion 11, an order-data storage portion 12, a data transfer controlling portion 13, a data transferring portion 14, a laser engine 16 and a printing-mode setting portion 17 have the same functions as those of the first embodiment.

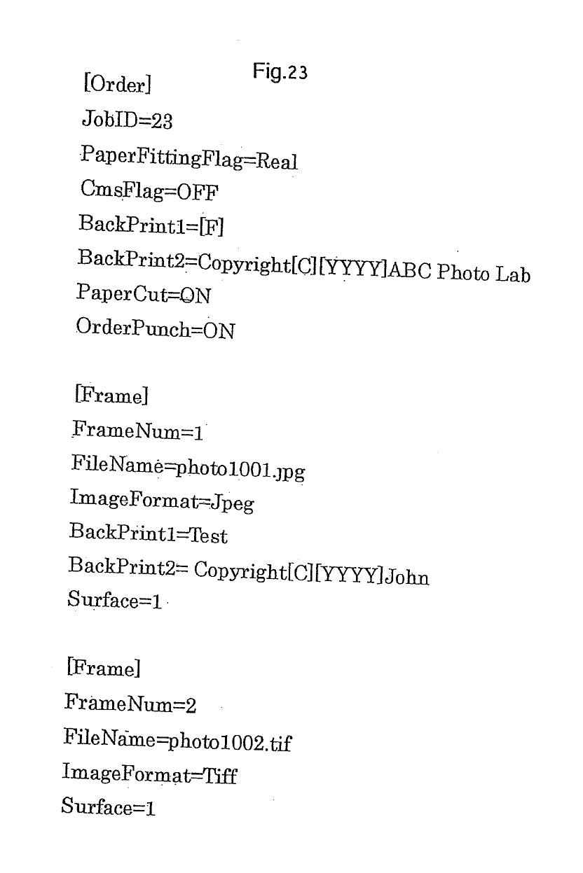

Image data acquired through the LAN is received by a data transmitting/receiving portion 18 and then is stored in a lower hierarchal folder set in a predetermined directory in a folder which is referred to as a hot folder 19. The hot folder 19 is constituted by a large-capacity storage device such as a hard disk. Print-size folders 19a (corresponding to first folders) for respective print sizes are set in the hot folder 19a and, further, a plurality of sub folders 19b (corresponding to second folders) are set in the respective print-size folders 19a. The sub folders 19b are set on an order-by-order basis, and each single sub folder 19a stores image data of a single order a printing-condition file (see FIG. 23). The print-size folders 19a are folders set on a print-size by print-size basis, for example, 127*89, 127*102, 205*254, wherein image data stored in the 127*89 folder is used for creating photograph prints with a print size of 127*89.

When the second mode is set, order data in the hot folder 19 is transferred to the laser controlling portion 15 through the data transfer controlling portion 13 and the data transferring portion 14. The laser engine 16 creates images in synchronization with the transfer speed of a photograph photo-sensitive material.

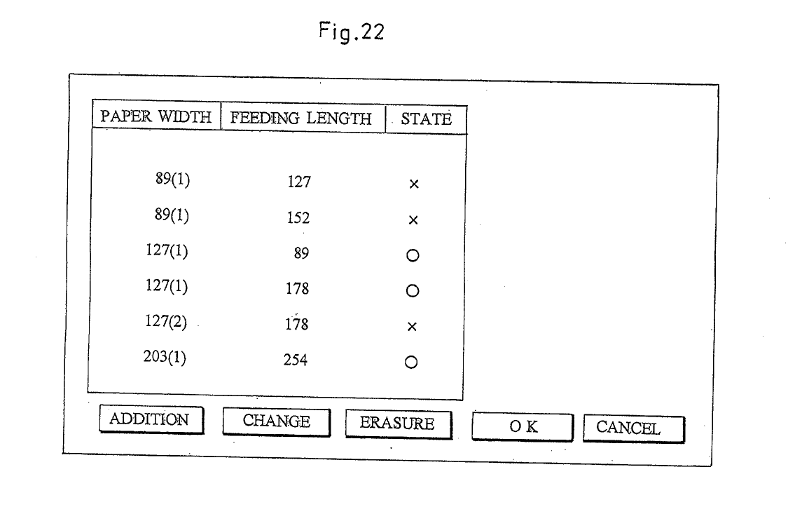

In the terminal processing devices 2, there is installed hot-folder addressing software 35 which is software used for generating commands for performing photograph-print creating processes, from the terminal processing devices 2 to the photograph-print creating device 1. Major functions thereof will be described. A list displaying means 35e has the function of displaying, on a monitor screen, a list of print sizes which can be provided from printing processes with the photograph-print creating device 1 connected to a LAN (one of the printing conditions). FIG. 22 illustrates an exemplary screen structure displaying such a list. There are displayed paper widths (mm), at the left side of the list. Further, there are displayed, next thereto, feeding lengths (mm). Print sizes having the same paper width but having different surface qualities such as mat and gloss surfaces are treated as different print sizes. In the figure, there are displayed 127(1) and 127(2), as papers with a width of 127 mm, wherein these papers are treated as papers of different print sizes since they have different surface qualities while having the same paper width. Print sizes having the same paper width but having different feeding lengths can be provided using the same paper. It can be recognized that the paper-width differences at the left side means differences of paper magazines 3.

Further, there are displayed, at the right side, round marks and cross marks which indicate states. The round marks indicate that the corresponding paper magazines 3 are currently mounted and, therefore, available for printing processes. The cross marks indicate that the corresponding paper magazines 3 are not currently mounted and, therefore, are not available for printing processes, but it is possible to make them available by replacing the paper magazine 3. Namely, the tabulated list shows a list of print sizes which can be processed with the photograph-print creating device 1. The operator can immediately recognize the processable print sizes by seeing the tabulated list. Print sizes which are not displayed therein can not be subjected to printing processes with the photograph-print creating device 1.

In the tabulated list, the determination as to whether the print sizes are available (round mark) or unavailable (cross mark) can be performed, on the basis of the functions of the processability determination means 35b. Namely, the photograph-print creating device 1 is provided with the function of detecting the paper information of the paper magazines 3 as will be described later and, by utilizing this function, it can be determined whether or not the paper magazines 3 are currently mounted.

The number of photograph-print creating devices 1 connected to the LAN is not limited to one. Two or more photograph-print creating devices 1 may be connected thereto. In such a case, a tabulated list can be displayed for each photograph-print creating device 1. When there are two or more photograph-print creating devices 1, these devices may be enabled to perform printing processes for different print sizes. Accordingly, the operator of the terminal processing device 2 can easily recognize which photograph-print creating device 1 should be used for performing printing processes.

A list setting means 35f offers the function of setting a tabulated list as illustrated in FIG. 22. Since the paper magazines 3 hold paper information thereon, the content of the tabulated list can be automatically set by reading the paper information. The content of the tabulated list can be set by the operator. By clicking an addition button displayed on the screen, a setting screen, not illustrated, is activated to enable setting the data of print sizes consisting of paper widths and feeding lengths. By clicking a changing button, the information about currently-set print sizes can be changed. By clicking an erasure button, the information about the currently-set print sizes can be erased.

A condition specification means 35g specifies, out of the print sizes displayed in the tabulated list, a print size (a printing condition) used for printing processes. For example, the specification may be performed for each order and, from the image data included in each order, photograph prints are created with the specified print size.

A printing-condition-file setting means 35i has the function of setting printing-condition files as illustrated in FIG. 23. These files include text data describing conditions of printing processes. For example, the conditions include the number of prints, the presence or absence of a border. The printing-condition files may be automatically created in conjunction with a predetermined operator's operation in the image processing portion 31 or may be directly created by operator's manual inputting.

A printing-process specification means 35a and a sub-folder creating means 35c have the same functions as those of the first embodiment.

An order-data transferring means 35b has the function of transferring order data (image data) relating to the order specified by the printing-process commanding means 35a, to the photograph-print creating device 1 through the LAN. At this time, on the basis of the print size data specified by the condition specification means 35g, the order data is transferred to a predetermined print-size folder 19a in the hot folder 19.

Next, there will be described functions of hot-folder addressing software 20 installed in the photograph-print creating device 1. A print-size-folder setting means 20a (corresponding to a first folder creating means) sets print-size folders 19a in the hot folder 19. FIG. 16 exemplifies, as print-size folders 19a, three folders 127*89, 127*102 and 205*254. While the folders may be set through operator's manual operations, the folder are automatically set by automatically recognizing current processable print sizes in the present invention.

First, two paper magazines 3 (designated by 3A and 3B) are detachably mounted to the photograph-print creating device 2 (see FIG. 20 and FIG. 21). The number of paper magazines 3 which can be mounted thereto can be properly set. There is provided a magazine-information detecting portion 22 which detects information about the paper magazines 3. The magazine-information detecting portion 22a has the function of detecting information about the mounted paper. The paper information corresponds to information about the width dimension of the housed paper, the surface quality of the paper (mat or gloss, etc.), the manufacturer name and the like. The paper information can be attached to the paper magazines 3 by attaching bar code labels or IC tags to the outer surfaces of the paper magazines 3 or forming, therethrough, bit holes indicating their paper information.

The magazine attachment/detachment detecting means 22b has the function of detecting the detachment of the paper magazines 3 and is capable of detecting the disengagement of any of the paper magazines 3 from the device. For example, the magazine attachment/detachment detecting means 22b can perform detections, on the basis of outputs from a switch or a sensor which operates in conjunction with the detachment and the movement of the paper magazines 3. The hot-folder addressing software 20 performs various types of processes, on the basis of the result of detection by the magazine-information detecting portion 21. As one of the processes, the print-size-folder setting means 20a creates print-size folders 19a, using the result of detection by the paper-information detecting means 21a. For example, when paper with a width of 127 mm housed therein is detected, the print-size-folder setting means 20a creates a folder for 127*89 and a folder for 127*102, as exemplified in FIG. 16. The folder names “127*89” and “127*102” designate print sizes (the paper width in mm*the feeding length in mm). Since the folder names include print sizes, it is possible to easily recognize which print-size folder 19a stores the order to be subjected to printing processes.

FIG. 16 illustrates the states of sub folders 19b set in print-size folders 19a. There are exemplified Order001 and Order002, as sub folders 19b. In the respective sub folders 19b, image data (image files) of a single order is stored. The creation of such sub folders 19b is performed on the basis of the function of the sub-folder creating means 35c which has been previously described. However, the creation of such sub folders 19b may be performed on the basis of the functions of the sub-folder creating means 20p in the photograph-print creating device 1.

An order checking means 20c, an extension controlling means 20d, and an order-data transferring means 20e have the same functions as the order checking means 20c, the extension controlling means 20d, and the order-data transferring means 20e according to the first embodiment.

A folder erasure means 20q has the same functions as that of the third embodiment.

A folder erasing means 20q has the following function. Namely, in the event that the magazine attachment/detachment detecting means 22b detects the disengagement of a paper magazine 3, the folder erasing means 20q erases the print-size folders 19b for the paper magazine 3. Consequently, in the hot folder 19, there are set only print-size folders 19a corresponding to print sizes which can be currently processed. It can be determined whether or not image data can be currently subjected to printing processes, on the basis of the setting of the print-size folders 19a.

An order moving means 20h has the following function. Namely, when there is still an unprocessed order in a print-size folder 19a which is to be erased by the folder erasure means 20q, the order moving means 20h moves the order data to another storage position. This can prevent the unprocessed image data from being erased along with the folder. In this case, it is also possible to employ a method of changing the folder name of the print-size folder 19a with a folder-name changing means 20i. Since the folder erasure means 20q erases folders on the basis of the folder names, it is possible to prevent unprocessed orders from being erased, by changing the folder names. When the paper magazine 3 for the print size having the changed folder name has been mounted again, a print-size folder 19a for the paper magazine 3 is created. Therefore, by returning the order data thereto at this time, printing processes can be performed thereon.

Even when a paper magazine 3 has been detached, the other paper magazine 3 may be used for performing printing processes, instead thereof. For example, it is assumed that the paper magazine 3A is to be removed, when printing processes for a print size of 89 mm (width)*127 mm (feeding length) are being performed with the paper magazine 3A. In this case, if the other paper magazine 3B houses paper with a width of 127 mm, the feeding length thereof can be set to 89 mm to enable continuously performing printing processes. Accordingly, by moving the order data into the print-size folder 19a based on the paper magazine 3B, printing processes can be performed on the order data. Therefore, when it is determined that order data can be processed as described above, the order moving means 20h moves the order data along with the sub folder 19b. This will change the relationship between the longitudinal and lateral sides of image data and, therefore, the images are subjected to rotating processes before the movement of the data.

The extensions of sub folders 19b created in the print-size folders 19a are the same as those in the first embodiment and, description thereof is omitted herein.

### [Procedure for Creating Print-Size Folders]

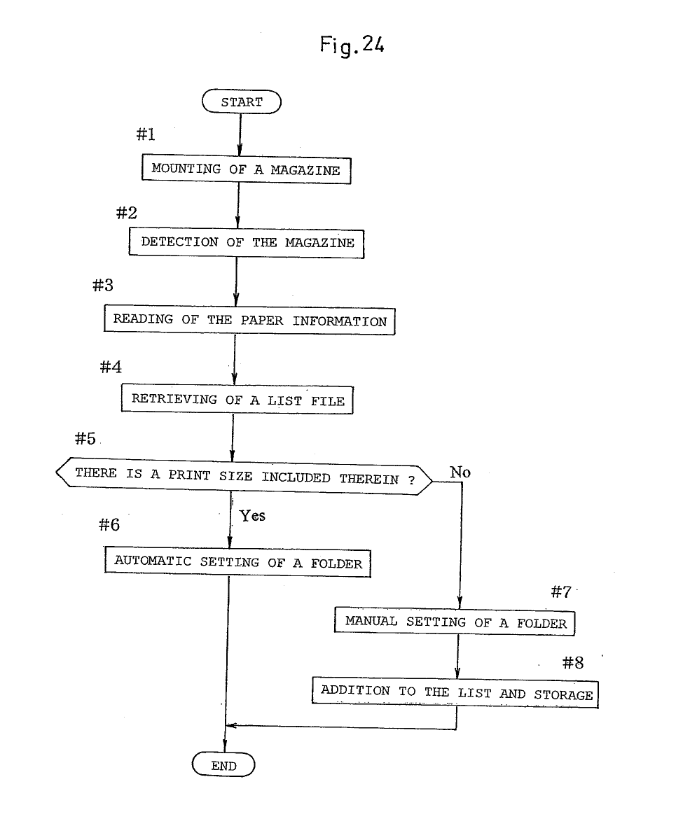

Next, with reference to a flow chart of FIG. 24, there will be described the procedure until print-size folders 19a are set, since paper magazines 3 are mounted to the device.

After a paper magazine 3 is disengaged from the device main body, another paper magazine 3 is mounted thereto (#1). The magazine attachment/detachment detecting means 22b detects the paper magazine 3 being mounted thereto (#2). Next, the paper information of the mounted paper magazine 3 is read (#3). Next, on the basis of the read paper information, a list file to be displayed by a list displaying means 35e is retrieved (#4). It is determined whether or not there are print sizes included in the list file (#5). When there are such print sizes, print-size folders 19a for the print sizes are automatically set (#6). When there is no such a print size, the addition button as described with FIG. 22 is operated to perform manual setting (#7). Next, the set data is added to the list file and stored (#8).

### [Procedure for Replacement of Magazines]

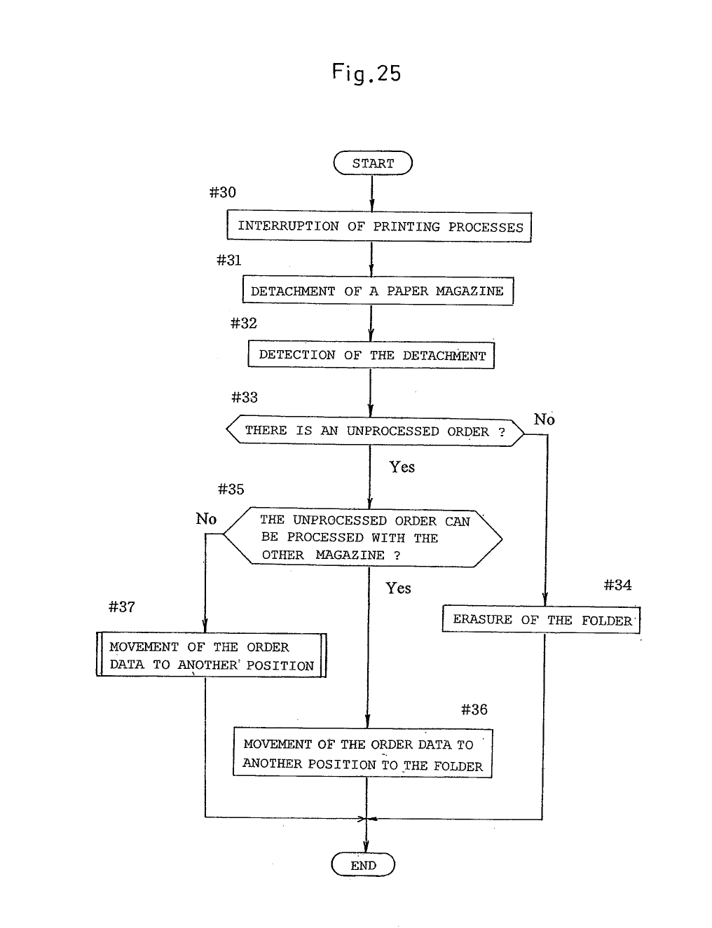

Next, with reference to a flow chart of FIG. 25, the procedure for replacement of paper magazines 3 will be described. The present invention is not limited to the following process procedure and various changes may be made thereto.

When a paper magazine 3 is to be detached, the printing process is temporarily interrupted at first (#30). Next, the paper magazine 3 is detached (#31). When the magazine attachment/detachment detecting means 21b detects the detachment of the paper magazine 3 (#32), the order checking means 20c determines whether or not there is still an unprocessed order (#33). When there is no unprocessed order, the print-size folders 19a for the paper magazine 3 are no longer necessary and therefore they are erased (#34).

When it is determined at the step #33 that there is still an unprocessed order, it is determined whether or not the unprocessed order can be processed with the other paper magazine 3 which is not detached (#35). When it can not be processed therewith, the order data (image data and a printing-condition file) is moved and evacuated to another storage position (#37). When it can be processed with the other paper magazine 3, the order data is moved to the print-size folder 19a for this paper magazine 3 (#36). In this case, the image data is subjected to a rotating process and the like, as required.

### Other Examples of the Fourth Embodiment

While, in the fourth embodiment, the hot-folder addressing software 20 in the photograph-print creating device 1 and the hot-folder addressing software 35 in the terminal processing devices 2 have been described as being separated from each other, these functions may be properly provided in any of the devices. Further, these software 20, 35 may be made identical to each other and their functions may be selectively utilized.

While, in the fourth embodiment, the magazine attachment/detachment detecting means 22b and the paper-information detecting means 22a are separately provided, the paper-information detecting means 22a may be structured to serve as the magazine attachment/detachment detecting means 22b.

Various types of changes may be made to the displaying form provided by the list displaying means 35e. While in FIG. 22 there are displayed three items which are paper widths, feeding lengths and states, in the form of a table, it is possible to additionally display other items (manufacturer names, print-size names (size L, size 2L and the like). Also, instead of using round marks and cross marks for indicating the states, it is possible to employ other displaying forms such as “currently mounted”, “currently detached” and the like.

While in the fourth embodiment there has been described a structure for storing data in the sub folders 19b on an order basis, orders may be set on a purchase-order basis or on a process basis. In the case of a process basis, for example, if a single purchase order for different print sizes is received, data may be stored in respective sub folders 19b on a size-by-size basis. In this case, this purchase order can be made distinguishable from the other purchase orders, for example, by attaching a sub number to the order number.

While, in the fourth embodiment, folders are created for only paper magazines 3 which are available for processes, it is possible to create main folders for all the printing conditions displayed in the form of a list as in FIG. 22 and, in cases where data is input to the folders, the paper magazines 3 may be replaced for performing printing processes on the input data.

While, in FIG. 16 in the fourth embodiment, printing-condition files are set in the respective sub folders 19b which are set on an order-by-order basis, default printing-condition files may be set in the respective print-size folders 19a at the same hierarchy level as the sub folders 19b therein and respective orders may be subjected to printing processes according to the default printing-condition files.

The paper for forming images thereon is not limited to a photograph photo-sensitive material and may be various types of paper.

### Fifth Embodiment

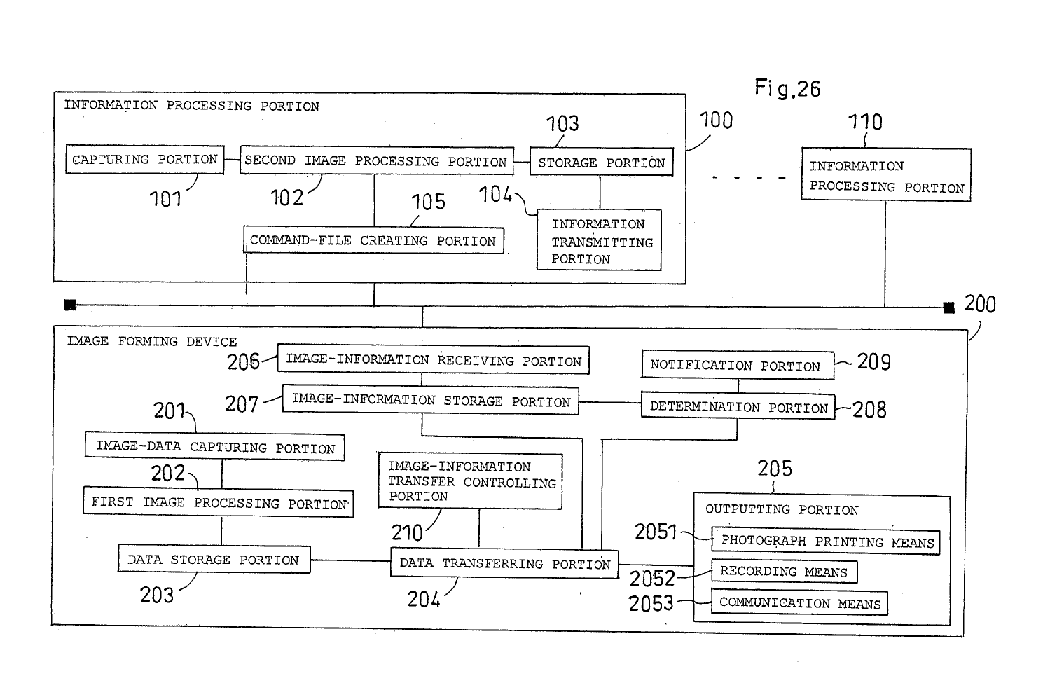

With reference to a block diagram of FIG. 26, there will be described main functions of a fifth embodiment of the photograph processing system illustrated in FIG. 1. In the fifth embodiment, components and flow-chart steps designated by the same reference characters have the same functions and, therefore, description of the previously-described components and steps may be omitted herein.

FIG. 26 is a block diagram illustrating the structure of an image forming system (corresponding to the photograph processing system) including information processing devices 100 and 110 and an image forming device 200, according to the present embodiment. The information processing device 100 includes a capturing portion 101 (corresponding to the image-data inputting portion), a second image processing portion 102, a storage portion 103 (corresponding to an order-data storing portion), an information transmitting portion 104 (corresponding to the data transmitting/receiving portion), and a command-file creating portion 105 (corresponding to the printing-condition-file setting means). The information processing device 110 includes the same components as those of the information processing device 100. The information processing devices have the same functions as those of the terminal processing devices according to the aforementioned first to fourth embodiments. The image forming device has the same functions as those of the photograph-print creating devices according to the aforementioned first to fourth embodiments.

The image forming device 200 includes an image-data capturing portion 201 (corresponding to the image-data inputting portion), a first image processing portion 202, a data storage portion 203 (corresponding to the order-data storage portion), a data transferring portion 204, an outputting portion 205, an image information receiving portion 206 (corresponding to the data transmitting/receiving portion), an image information storage portion 207 (corresponding to the hot folder), a determination portion 208, a notification portion 209, and an image information transfer controlling portion 210. The outputting portion 205 includes a photograph printing means 2051, a recording means 2052, and a communication means 2053. The information processing devices 100 and 110 are connected to the image forming device 200 through a local area network. Also, the information processing devices 100 and 110 may be connected to the image forming device 200 through other connecting means such as wireless means or the internet.

Hereinafter, the respective structures of the information processing device 100 and the image forming device 200 will be described. The information processing device 100 or the image forming device 200 includes a CPU, an MPU, a memory, a control bus, a data bus, an inputting means such as a keyboard or mouse, a displaying portion such as a liquid crystal display screen, a storage medium such as a hard disk, and the like.

The capturing portion 101 or the image-data capturing portion 201 acquires image data.

The capturing portion 101 or the image-data capturing portion 201 converts images into data and captures the data and is constituted by, for example, a digital still camera, a digital video camera, an image scanner. When the capturing portion 101 captures image data from various types of films (for example, 135 color negatives, 135 black-and-white negatives, 135 positives and APS negatives), the capturing portion 101 may be realized by a film scanner and the like.

Also, when the capturing portion 101 or the image-data capturing portion 201 captures image data recorded in mediums (for example, CD-Rs, DVDs, MOs, ZIPs and the like), the capturing portion 101 or the image-data capturing portion 201 can be realized by a reading device provided for such mediums and a controlling means therefor. When such mediums are DVDs, for example, the capturing portion 101 may be realized by a DVD drive and a DVD driver.

The capturing portion 101 or the image-data capturing portion 201 may also receive image data from external devices through wire communication or wireless communication. In such a case, the capturing portion 101 or the image-data capturing portion 201 may be realized by a receiving means. The procedure for reception is generally realized by software which is recorded in a recording medium such as a ROM. However, it may be realized by hardware (a dedicated circuit).

The second image processing portion 102 performs image processing on image data captured by the acquiring portion 101. The term “image processing” means processing for creating, from image data, printing image data for creating photograph prints with proper or desired image qualities. The procedure of the processing is as follows. First, color correction parameters and density correction parameters are set, for the colors and the densities of image data. Further, when there exists red-eye, red-eye correction parameters are also set. Further, the settings of correction parameters for specific corrections such as backlight corrections are also made, as required. Further, the settings of the print size, the number of prints and the like are also made. A user makes the setting of these correction parameters by manually imputing them with the inputting means while directly seeing the image data displayed on the displaying portion. Next, on the basis of the image data and the correction parameters, printing image data is created. The procedure for the creation is generally realized by a dedicated image processing processor. It goes without saying that image data can be directly printed without being subjected to image processing. In such a case, image data can be directly stored in the storage portion 103 as printing image data, without being subjected to image processing.

The first image processing portion 202 performs image processing on the image data captured by the image-data acquiring portion 201 to create printing image data.

The first image processing portion 202 or the second image processing portion 102 may be generally realized by an MPU, a memory or the like. The first image processing portion 202 or the second image processing portion 102 may include, for example, an image processing processor for realizing high-speed processes. The procedure for image processing is generally realized by software which is recorded on a recording medium such as a ROM. However, it may be realized by hardware (a dedicated circuit).

The storage portion 103 stores image information. The “image information” includes the printing image data created from the processing by the second image processing portion 102 and process information about the printing image data. The “process information about the printing image data” means, for example, data defining printing conditions, such as the print size of photograph prints, the number of prints, data to be printed on the back surfaces of prints. The “process information about the printing image data” may be “command data” created by the command file creating portion 105 which will be described later. The storage portion 103 stores the printing image data and the “process information about the printing image data” in association with each other.

The information transmitting portion 104 transmits the image information stored in the storage portion 103 to the image forming device 200. The information transmitting portion 104 may be realized by a transmitting means. Also, the information transmitting portion 104 may be realized by a wireless communication means.

The command-file creating portion 105 creates command files. The term “command files” means files of command data describing information about processing for printing image data. The “command data” is data defining printing conditions such as the print size of photograph prints, the number of prints, the content of data to be printed on the back surfaces of prints. On the basis of the “command data” and the “printing image data” corresponding thereto, photographs can be created. The command-file creating portion 105 may be generally realized by an MPU, a memory or the like. The procedure for performing the process for creating a command file is generally realized by software which is recorded on a recording medium such as a ROM.

The data storage portion 203 stores the printing image data created by the first image processing portion 202.

The storage portion 103 or the data storage portion 203 is preferably a nonvolatile recording medium. However, the storage portion 103 or the data storage portion 203 may be also realized by a volatile recording medium.

The data transferring portion 204 transfers the printing image data stored in the data storage portion 203 to the outputting portion 205. Also, the data transferring portion 204 may transfer image information stored in the image-information storage portion 207 to the outputting portion 205, when the determination portion 208, which will be described later, determines that it is necessary to secure a storage region. Also, the data transferring portion 204 may transfer image information stored in the image-information storage portion 207 to the outputting portion 205, when the image information transfer controlling portion 210, which will be described later, receives a command for outputting image information stored in the image-information storage portion 207.

The outputting portion 205 outputs the image information transferred from the data transferring portion 204. Further, the outputting portion 205 outputs the printing image data transferred from the data transferring portion 204. The outputting portion 205 has the same functions as those of the printer processor 1B according to the first embodiment.

When the data is recorded on a medium such as a CD-R, the image information is transferred to the recording means 2052. The recording means 2052 records the transferred image information onto various types of mediums. The recording means 2052 may be realized by a recording device and a controlling means provided for such mediums. For example, when data is recorded onto CD-Rs, the recording means 2052 may be realized by a CD-R drive and a driver therefor.

When data is transmitted to an external image processing device, the image information is transferred to the communication means 2053. The communication means 2053 may be realized by a wireless communication means, a communication means, a broadcasting means or the like.

The image-information receiving portion 206 receives image information. The image-information receiving portion 206 receives image information from the information transmitting portion 104 in the information processing device 100. The image-information receiving portion 206 may be realized by a receiving means.

The image-information storage portion 207 stores image information received by the image-information receiving portion 206. The image-information storage portion 207 is preferably a nonvolatile recording medium. However, it may be also realized by a volatile recording medium. Also, the image-information storage portion 207 may be, for example, a hot folder in a hard disk incorporated in the image forming device 200.

The determination portion 208 determines whether or not it is necessary to secure a data storage region in the image-information storage portion 207. The term “determining whether or not it is necessary to secure a storage region” means calculating the capacity of the free space of the image-information storage region 207 for storing data and then determining whether or not the calculated capacity of the free space is equal to or greater than a predetermined capacity. In this case, the term “when it is determined that it is necessary to secure a storage region” means “when it is determined that the calculated capacity of the free space is not equal to or greater than the predetermined capacity”. Also, the term “determining whether or not it is necessary to secure a storage region” means, for example, calculating the number of image information stored in the image-information storage region 207 and then determining whether or not the calculated number is equal to or greater than a predetermined number. In this case, the term “when it is determined that it is necessary to secure a storage region” means “when it is determined that the calculated number is equal to or greater than the predetermined number”. Also, the determination portion 208 may calculate the capacity of image information accumulated in the image-information storage portion 207 and may determine whether or not the calculated capacity exceeds a predetermined value (for example, 70% of the data storage capacity of the image-information storage portion 207). In this case, the term “when it is determined that it is necessary to secure a storage region” means “when it is determined that the calculated capacity exceeds the predetermined value”. Also, the determination portion 208 determines whether or not the capacity of the free space of a recording medium for accumulating image information therein is equal to or less than a predetermined capacity and, in this case, the term “when it is determined that it is necessary to secure a storage region” means “when it is determined that the capacity of the free space of the recording medium for accumulating image information therein is equal to or less than the predetermined capacity.

When the determination portion 208 determines that it is necessary to secure a storage region, the notification portion 209 generates a notification of information about the storage region. The term “information about the storage region” means information which calls attention to the reduction of the storage region, such as information about the fact that “the capacity of the free space of the storage region has been reduced and it will be impossible to store image information therein, over time”, information about the fact that “the total capacity of stored image information has reached 80% of the storable capacity of the hot folder”, information about the fact that “the number of sub folders or the capacity of stored image information has been increased and it will be impossible to store image information in the hot folder”. The destination of “notification” may be either the image forming device 200 itself or the information processing device 100.

The term “generating a notification” means, for example, displaying on a display device, printing, outputting sound. In the case of generating a notification onto a display device, the notification portion 209 creates “information about the storage region” and displays it on the display device. In this case, the notification portion 209 may be generally realized by an MPU, a memory or the like. The procedure for creating “information about the storage region” and displaying it on the display device may be generally realized by software which is recorded in a recording medium such as a ROM. The term “creating” may mean, for example, reading “information about the storage region” which has been stored in advance in a memory incorporated in the image forming device 200. The “information about the storage region” may be manually input from an inputting means (not shown).

Also, in the case of printing, the notification portion 209 creates “information about the storage region” and outputs it to a printer which is not illustrated.

Also, in the case of outputting sound, the notification portion 209 may synthetically create, for example, a sound “peep”, a voice “there is not enough free space in the hot folder and, please perform printing out” and may output it to a speaker. The means for synthetically creating sound or voice is a conventional technique and, therefore, detailed description of the synthesizing means is omitted herein.

The image-information transfer controlling portion 210 receives a command for outputting image information stored in the image-information storage portion 207. The term “a command for outputting image information” means, for example, a command generated when the outputting process for printing image data resulted from processing by the first image processing portion 202 has been completed. The term “when the outputting process for printing image data resulted from processing by the first image processing portion 202 has been completed” means, for example, when there is no printing image data to be subsequently transferred, in the storage portion 203, when the first image information processing portion 202 is not newly executing image processing, when the outputting portion 205 has not received data to be newly output, after completing the outputting process for printing image data. The image-information transfer controlling portion 210 may receive “a command for outputting image information”, from the data transferring portion 204, the first image processing portion 202, the outputting portion 205 or controlling means (not shown) which generates commands for outputting image information. The image-information transfer controlling portion 210 may receive “a command for outputting image information” from the determination portion 208 or the notification portion 209. In this case, the determination portion 208 or the notification portion 209 generates “a command for outputting image information”, “when it is determined that it is necessary to secure a storage region”.

On receiving “a command for outputting image information”, the image-information transfer controlling portion 210 commands the data transferring portion 204 to transfer image information from the image-information storage portion 207 to the outputting portion 205. Then, the data transferring portion 204 reads image information from the image-information storage portion 207 and transfers it to the outputting portion 205. The data transferring portion 204 may transfer image information in descending order or ascending order of storing date. Also, the data transferring portion 204 may preferentially select image information which is required to be urgently printed as photographs and may transfer it. Also, image information, its index or thumbnail images thereof may be displayed on a display device so that it can be selected through the inputting means.

Also, the data transferring portion 204 may have the functions of the image-information transfer controlling portion 210. In this case, the data transferring portion 204 may generate a command for reading image information stored in the image-information storage portion 207 and transferring it to the outputting portion 205.

The determination portion 208, the notification portion 209 or the image information transfer controlling portion 210 may be generally realized by an MPU, a memory or the like. The aforementioned procedure may be generally realized by software which is recorded in a recording medium such as a ROM.

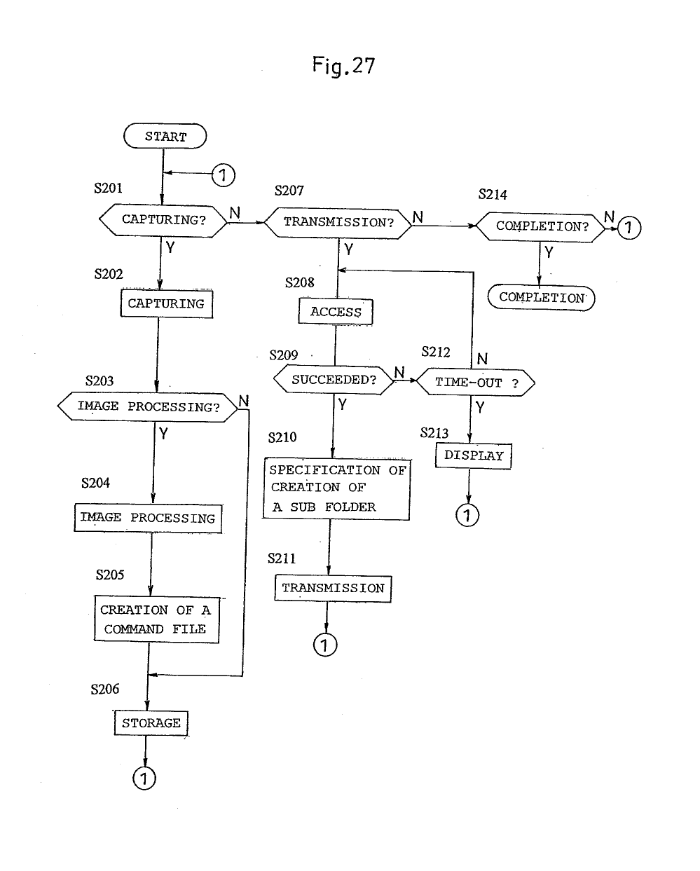

Hereinafter, the operation of the image forming system will be described. First, the operation of the information processing device 100 will be described with reference to a flow chart of FIG. 27.

The capturing portion 101 determines whether or not image data is to be captured (S201). If image data is to be captured, the process proceeds to a step S202, otherwise, proceeds to a step S207.

The capturing portion 101 captures image data (S202).

The second image processing portion 102 determines whether or not the image data captured at the step S202 should be subjected to image processing (S203). If it should be subjected to image processing, the process proceeds to a step S204, otherwise, the process proceeds to a step S206.

The second image processing portion 102 performs image processing on the image data captured at the step S202 to create printing image data (S204).

The command-file creating portion 205 creates a command file for the printing image data created at the step S204 (S205).

The printing image data and the command file created at the step S205 are accumulated in the storage portion 103, as a pair (S206). The accumulated data is image information. The process returns to the step S201.

The information transmitting portion 104 determines whether or not the image information accumulated at the step S206 should be transmitted (S207). If it should be transmitted, the process proceeds to a step S208, otherwise, the process proceeds to a step S214. The term “when it should be transmitted” means, for example, when there is image information in the storage portion 103 or when the information transmitting portion 104 has received a command for transmission.

The information transmitting portion 104 accesses the image forming device 200 (S208), when it is determined at the step S207 that the image data should be transmitted.

The information transmitting portion 104 determines whether or not the access was successfully attained at the step S208 (S209). If the access was succeeded, the process proceeds to a step S210. If the access failed, the process proceeds to a step S212. The term “access fails” means, for example, that there is no data-writing region in the image-information storage portion 207 of the image forming device 200, or the image-information receiving portion 206 is receiving data from another information processing device 110.

The information transmitting portion 104 commands the image-information storage portion 207 to create a sub folder (S210). This command is, for example, a command for creating a sub folder in the hot folder in the hard disk.

The information transmitting portion 104 acquires the image information from the storage portion 103 and transmits the image information (S211). After the transmission, the process returns to the step S201.

The information transmitting portion 104 determines whether or not an access time has elapsed (S212). If it has elapsed, the process proceeds to a step S213 or if it has not elapsed, the process returns to the step S208.

The display portion, not illustrated, displays information about the fact that the access time has elapsed at the step S212 (S213). The display portion may be, for example, a liquid crystal display, a CRT monitor or the like. The term “information about the fact that the access time has elapsed” means, for example, information indicating that “transmission of image data is impossible”. The means for displaying on the display portion is a conventional technique and detailed description thereof is omitted herein. After the displaying, the process returns to the step S201.

An interruption means, not illustrated, determines whether or not the operation of the information processing device 100 should be terminated (S214). If the operation should be terminated, the operation is terminated, otherwise, the process returns to the step S201. The term “when the operation should be terminated” means, for example, when the interruption means should turn off a switch of the operation power supply. The interruption means may be a conventional technique and, therefore, description thereof is omitted herein.

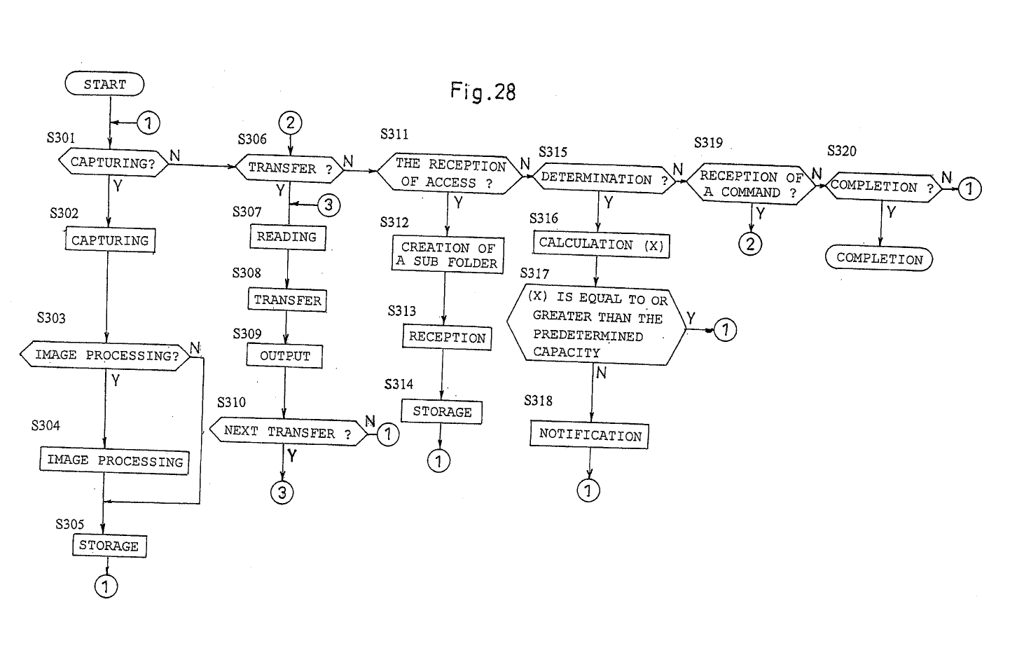

Next, with reference to a flow chart of FIG. 28, the operation of the image forming device 200 will be described.

The image data capturing portion 201 determines whether or not image data should be captured (S301). If it should be acquired, the process proceeds to a step S302, otherwise, proceeds to a step S306.

The image data capturing portion S201 captures image data (S302).

The first image processing portion 202 determines whether or not the image data should be subjected to image processing (S303). When it should be subjected to image processing, the process proceeds to a step S304, otherwise, the process proceeds to a step S305. This determination may be performed as follows. That is, the image data captured by the image data acquiring portion 201 may be displayed on a displaying means such as a liquid crystal display and, when a user determines that the displayed image data should be subjected to corrections, he or she may generate a command therefor from the inputting means. Also, an image processing processor or software may determine whether or not the image data should be processed, according to a method using a specific algorism. The “specific algorism” is a conventional technique and description thereof is omitted herein.

The first image processing portion 202 performs image processing on the image data to create printing image data (S304). In this case, the image data captured by the image data acquiring portion 201 may be displayed on a displaying means such as a liquid crystal display and the user may properly set correction parameters for colors and densities while seeing the displayed image data. Also, an image processing processor or the like may automatically set correction parameters. On the basis of the various types of correction parameters which have been set and the image data, an image processor or the like creates printing image data.

The printing image data created at the step S304 is accumulated in the data storage portion 203 (S305). After the accumulation, the process returns to the step S301.

The data transferring portion 204 determines whether or not various types of data should be transferred (S306). When data should be transferred, the process proceeds to a step S307, otherwise, the process proceeds to a step S311. The term “when data should be transferred” means, for example, when printing image data has been stored in the data storage portion 203 or when the outputting portion 205 has completed outputting operations. Also, the data transferring portion 204 may determine that data should be transferred, when it receives “a command for outputting image information” from the image-information transfer controlling portion 210.

The data transferring portion 204 reads printing image data (S307). The data transferring portion 204 reads printing image data from the data storage portion 203, when the printing image data has been stored in the data storage portion 203. The data transferring portion 204 reads printing image data from the image-information storage portion 207, when the outputting portion 205 has completed outputting operations, for example. The data transferring portion 204 reads printing image data from the image-information storage portion 207, when it receives “a command for outputting image information” from the image-information transfer controlling portion 210.

The data transferring portion 204 transfers the various type of data read at the step S307 to the outputting portion 205 (S308).

The outputting portion 205 outputs the data transferred at the step S308 (S309). The term “outputting” means that the photograph printing means 2051 prints photographs on the basis of the transferred data, in the case of printing photographs. Further, when the transferred data is stored, the storage means 2052 records and stores the transferred data into various types of recording mediums. Also, when the transferred data is transmitted, the communication means 2053 transmits the transferred data to an external PC.

The data transferring portion 204 determines whether or not next data should be transferred (S310). When next data should be transferred, the process returns to the step S307, otherwise, the process returns to the step S301. The term “when next data should be transferred” means, for example, when there is un-transferred image information in the image-information storage portion 207, when there is un-transferred printing image data in the data storage portion 203.

The image-information receiving portion 206 determines whether or not it should receive data access from any of the information processing devices (100, 110 and the like) (S311). When it should receive access, the process proceeds to a step S312. When it should not receive access, the process proceeds to a step S315. The term “when it should not receive access” means, for example, when the image-information receiving portion 206 is accessing another information processing device, when there is not enough free space for storing data in the image-information storage portion 207, or when access is forcibly prohibited due to power shutdown, interruption and the like.

The image-information receiving portion 206 receives a command for creation of a sub folder, from the information processing device 100 (S312). Next, on the basis of the command, the controlling means, not illustrated, creates a sub folder in the image-information storage portion 207. Here, the controlling means may be realized by a CPU, a memory and the like, and the procedure therefor may be realized by software. Also, the sub folder may be created in the hot folder in the image-information storage portion 207.

The image-information receiving portion 206 receives image information from the information processing device 100 (S313).

The image information received at the step S313 is stored in the image-information storage portion 207 (S314). After the storing, the process returns to the step S301.

The determination portion 208 determines whether or not it should perform determination (S315). When it should perform determination, the process proceeds to a step S316, otherwise, the process proceeds to a step S319. The term “when it should perform determination” means, for example, when it should perform determination at regular time intervals (for example, at 30-min intervals, at one-hour intervals), when it should perform determination after the image-information receiving portion 206 receives image information, when it should perform determination after image information is stored in the image-information storage portion 207, when it should perform determination at other timings, wherein the timing of determination can be properly selected depending on the usage condition, user's selection and setting and the like.

The determination portion 208 calculates the capacity (x) of the free space of the data storage region of the image-information storage portion 207 (S316). The calculation of the capacity (x) of the free space may be performed either by the determination portion 208 or an operation control system (not shown) which controls the operation of the image forming device 200. In the latter case, the determination portion 208 commands the operation controlling system to calculate the capacity (x) of the free space, then the operation controlling system performs the calculation on the basis of the command, and the determination portion 208 acquires the capacity (x) of the free space resulted from the calculation.

The determination portion 208 determines whether or not the capacity (x) of the free space calculated at the step S316 is equal to or greater than a predetermined capacity (S317). If the capacity (x) of the free space is equal to or greater than the predetermined capacity, the process proceeds to the step S301, otherwise, the process proceeds to a step S318. The term “predetermined capacity” means an arbitrary value indicating reduction of the capacity of the free space and may be, for example, 30% or 20% of the data storage capacity of the image-information storage portion 207. Also, when the reduction of the data storage capacity may cause instable operations of the image forming device 200, the “predetermined capacity” may be set to a data storage capacity which will not cause instable operations. In such a case, the operation of the image forming device 200 may be checked, in advance, to detect operation instability, and the capacity of the free space may be determined at this time. If the capacity (x) of the free space of the image-information storage region 207 reaches the determined capacity of the free space, it may be determined that the operation is instable. Also, the operation controlling system, not illustrated, may monitor the performance of the image forming device 200 and, if the image processing speed is decreased, if the output processing speed is decreased, or if the data transferring speed is decreased, for example, the operation may be determined to be instable, then the capacity of the free space at the time of the determination may be calculated and the calculated value may be set to the “predetermined capacity”.

The notification portion 209 generates a notification of information about the storage region (S318). The notification portion 209 may also generates a notification of the capacity (x) of the free space calculated at the step S317. Next, the process returns to the step S301. Further, the notification portion 209 may commands the data transferring portion 204 to transfer image information from the image-information storage portion 207. In response to the notification, the data transferring portion 204 may read image information from the image-information storage portion 207 and may transfer it to the outputting portion 205. When the notification portion 209 generates the aforementioned command to the data transferring portion 204, the process may proceed to the step S306.

The image-information transfer controlling portion 210 determines whether or not it has received a command for outputting image information stored in the image-information storage portion 207 (S319). If it has received such a command, the process proceeds to the step S306, otherwise, the process proceeds to a step S320.

An interruption means, not illustrated, determines whether or not the operation of the information processing device 200 should be terminated (S320). If the operation should be terminated, the operation is terminated, otherwise, the process returns to the step S301. The term “when the operation should be terminated” means, for example, when the interruption means should turn off a switch of the operation power supply. The interruption means may be a conventional technique and, therefore, description thereof is omitted herein.

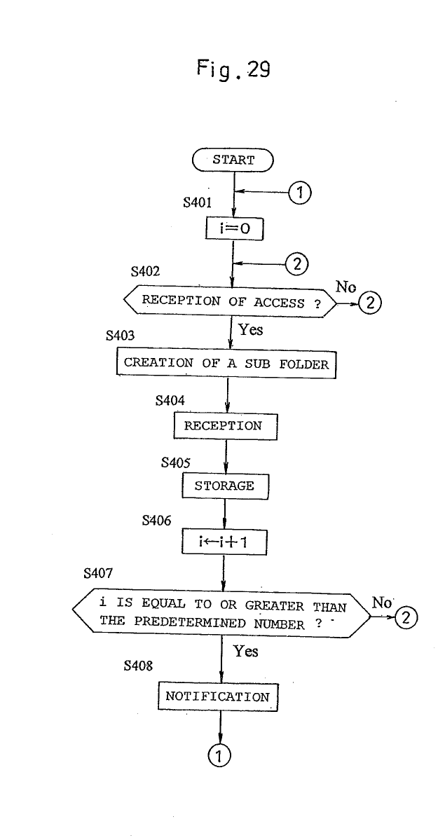

Hereinafter, with reference to a flow chart of FIG. 29, there will be described another determining method executed by the determination portion 208.

The determination portion 208 initializes i to 0 (S401).

The image-information receiving portion 206 determines whether or not it should receive data access from any of the information processing devices (100, 110 and the like) (S402). If it should receive access, the process proceeds to a step S403, otherwise, the process proceeds to a step S402.

The image-information receiving portion 206 receives a command for creating a sub folder, from the information processing device 100 (S403). Next, on the basis of the command, the controlling means, not illustrated, creates a sub folder in the image-information storage portion 207.

The image-information receiving portion 206 receives image information from the information processing device 100 (S404).

The image information received at the step S404 is stored in the image-information storage portion 207 (S405).

The determination portion 208 increments i (i is replaced with i+1) (S406).

The determination portion 208 determines whether or not the value (i) calculated at the step S406 is equal to or greater than a predetermined number (S407). If the value (i) is equal to or greater than the predetermined number, the process proceeds to a step S408, otherwise, the process proceeds to a step S402. The “predetermined number” is an arbitrary number. For example, in the case where the average capacity (for example, 5 MB) per unit image information is defined in advance, the “predetermined number” may be a value (for example, 150) smaller than the value (200=1 GB/5 MB) resulted from the division of the storage capacity (for example, 1 GB) of the image-information storage portion 207 by the average capacity (5 MB).

The notification portion 209 generates a notification of information about the storage region (S408). After the notification, the process returns to the step S401.

Hereinafter, there will be described detail operations of the information processing device 100 and the image forming device 200 in the image forming system according to the present embodiment.

First, the capturing portion 101 of the information processing device 100 captures image data from a storage medium storing various types of image data. Here, the DVD drive of the capturing portion 101 captures image data stored in a DVD.

Next, the second image processing portion 102 performs corrections on the captured image data, in terms of, for example, color, density and the like, to create printing image data. Next, the command-file creating portion 105 creates a command file for the printing image data. Next, the printing image data and the command file are stored, as a pair. The printing image data file and the command file are set as image information. Further, the image information may include other information, such as information about printing priority, information about desired completion time and the like.

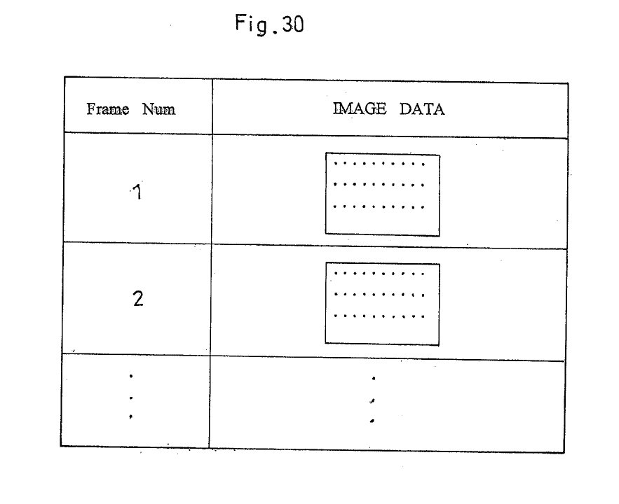

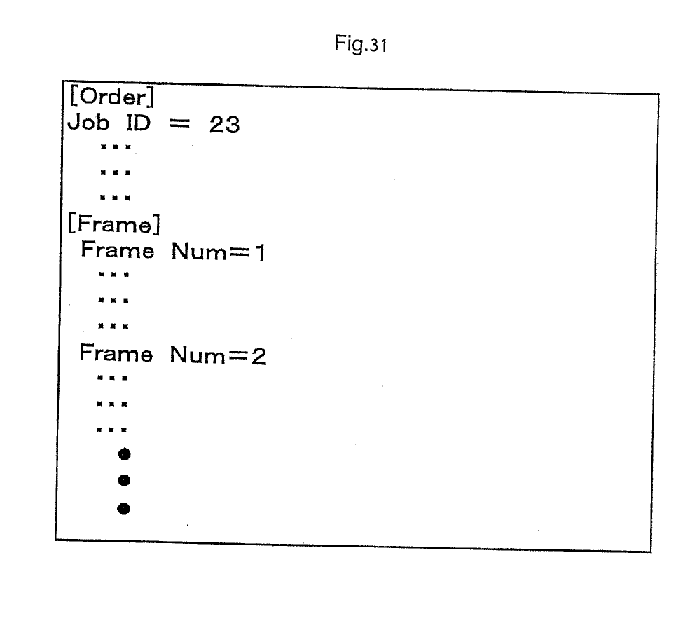

FIG. 30 is a view illustrating exemplary printing image data. “Frame Num” represents frame numbers of printing image data. The file format of data may be, for example, GIF, JPEG, BMP and the like and, in this case, the file format is a JPEG format. The data structure may be, for example, an arrangement, a list structure, a tree structure and the like and may be an arbitrary data structure, in this case. FIG. 31 is a view illustrating an exemplary command file. “Frame Num” corresponds to the frame numbers of the printing image data of FIG. 30. The command file is created in a text format.

Next, when the image-information receiving portion 206 receives access, the information transmitting portion 104 generates a command for creating a sub folder in the hot folder (the image-information storage portion 207). In response to the command, a sub folder is created in the hot folder.

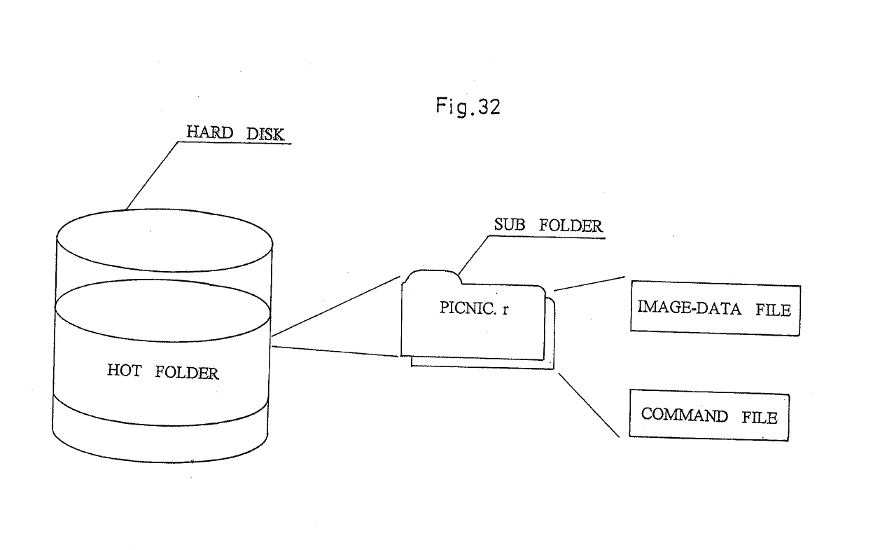

Next, the information transmitting portion 104 transmits the pair of the printing image data file and the command file, and the image-information receiving portion 206 receives them. Then, the received printing image data file and the received command file are stored in the sub folder. FIG. 32 is a view illustrating an exemplary sub folder created in the hot folder. The hot folder is created in the hard disk. The sub folder is created at a portion of the hot folder. The sub folder has a file name of “picnic. r”. The sub folder “picnic. r” includes a printing image data file and a command file. The data structure in the hot folder is not particularly limited. Here, the function of changing the extension of a sub folder will be briefly described. When a sub folder is created in the hot folder, the extension of the sub folder is set to, for example, “r”. Then, the sub folder is transferred to the outputting portion 205 and, when the outputting portion 205 has successfully completed an outputting process thereon, the extension of the sub folder is changed to, for example, “c”. When the transferring process or the outputting process was not succeeded, the extension of the sub folder is set to, for example, “e”. Namely, it is possible to distinguish whether or not the sub folder has been subjected to an outputting process, from its extension. Also, it is possible to distinguish whether or not the outputting process was succeeded. Accordingly, there is no need for providing a flag indicating files have been output, and it is possible to distinguish the states of files, from their extensions. For example, the data transferring portion 204 may be structured to transfer only sub folders with an extension of “r” or “e” while not transferring sub folders with an extension of “c”. The aforementioned changing function may be realized by a controlling means, not illustrated.

As described above, the image forming device 200 successively receives image information from the information processing devices 100, 110 and 120 and creates sub folders in the hot folder.

Thus, the number of sub folders in the hot folder is gradually increased. Before the operation of the image forming device 200 becomes instable or before it becomes impossible to store image information in the hot folder, the notification portion 209 generates a notification of “information about the storage region”. The concrete procedure for the aforementioned notification operation will be described.

First, the determination portion 208 calculates the capacity (x) of the free space of the hot folder. Here, as to the timing of the calculation, the determination portion 208 calculates the capacity (x) of the free space just after image information is stored in the hot folder.

Next, the determination portion 208 determines whether or not the capacity (x) of the free space is equal to or greater than a predetermined capacity. Here, the “predetermined capacity” is set to 30% of the data storage capacity of the hot folder. This is a capacity selected in order to secure a sufficient free space, such that image information can be received and stored during determination by the determination portion 208, for preventing the failure of storage of image information during the determination. Here, in the case where the storage region of the hot folder has a capacity of “1 GB”, the “predetermined capacity” is set to 300 MB. However, it goes without saying that the “predetermined capacity” is not limited to 300 MB, which is selected herein.

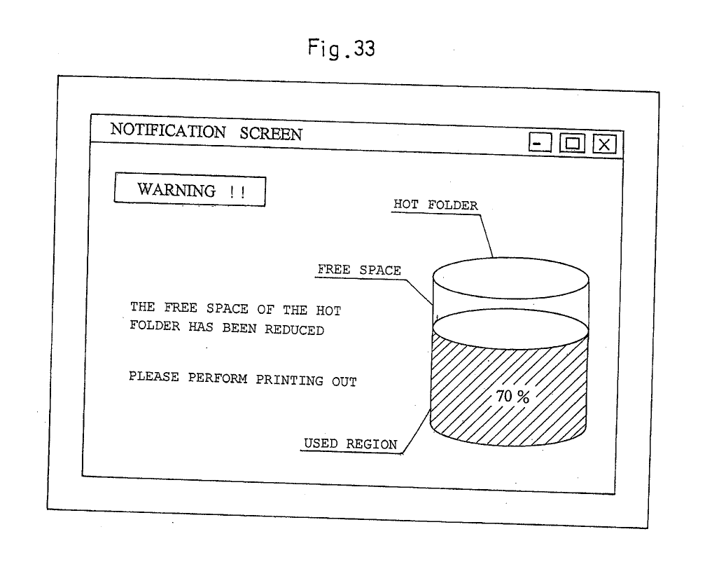

If the capacity (x) of the free space is not equal to or greater than the “predetermined capacity (300 MB)”, the notification portion 209 creates information about the storage region and displays it on a liquid crystal display of the image forming device 200. The notification portion 209 reads “information about the storage region (display of warning; the free space of the hard disk has been reduced)”, which has been stored in advance in a memory incorporated in the image forming device 200, and transmits the information to the operation controlling means (not shown) for the liquid crystal display. Further, the notification portion 209 reads “a conceptual view illustrating that data is stored in the hot folder up to 70% thereof”, which has been stored in advance in the memory incorporated in the image forming device 200, and transmits the information to the operation controlling means (not shown) for the liquid crystal display. Then, the operation controlling means (not shown) displays a window for providing a notification of information, on the screen of the liquid crystal display. Subsequently, the operation controlling means (not shown) displays the characters “Warning !!, the free space of the hot folder has been reduced and, please perform printing out !!!.” and “the conceptual view illustrating that data is stored in the hot folder up to 70% thereof”, on the window. FIG. 33 is a view illustrating exemplary information displayed on the liquid crystal display.

The aforementioned structure allows a user of the image forming device 200 to recognize that the free space of the hot folder has been reduced and to output image information from the hot folder for increasing the storage region of the hot folder, before it becomes impossible to receive image information. Namely, the user of the image forming device 200 can command the image forming device 200 to output image information stored in the image-information storage portion 207. The user may generate such a command by setting a mode for preferentially outputting image information. In such a mode, for example, image information stored in the image-information storage portion 207 is preferentially output while image data captured by the image-data capturing portion 201 is subjected to image processing to create printing image data and the printing image data is accumulated in the data storage portion 203. Then, when image information stored in the image-information storage portion 207 has been evacuated, printing image data accumulated in the data storage portion 203 is output. Also, in a mode for preferentially outputting printing image data accumulated in the data storage portion 203, only printing image data accumulated in the data storage portion 203 is output and, even when there is no printing image data in the data storage portion 203, image information stored in the image-information storage portion 207 is not output. Further, the image-information transfer controlling portion 210 may have the function of setting the modes.

Also, if the determination portion 208 determines that the capacity (x) of the free space is not equal to or greater than the “predetermined capacity (300 MB)”, the determination portion 208 commands the data transferring portion 204 to read image information and transfer it to the outputting portion 205. Then, the data transferring portion 204 reads image information from the image information storage portion 207 and transfers it to the outputting portion 205. In the case where the data transferring portion 204 is being involved in the transfer of printing image data from the data storage portion 203 at this time, after the transfer is completed the data transferring portion 204 reads image information from the image-information storage portion 207 and transfers it to the outputting portion 205. This process is performed without being affected by the aforementioned modes. Namely, even in “the mode for preferentially outputting printing image mode accumulated in the data storage portion 203”, the data transferring portion 204 performs processes for reading image information from the image-information storage portion 207 and then transferring it, in response to the aforementioned command.

With the aforementioned structure, image information can be automatically subjected to outputting processes, even when the user does not recognize a notification of information about the storage region and does not input a command for outputting.

Next, the outputting portion 205 performs outputting on the basis of the transferred image information. Here, the photograph printing means 2051 creates photographs. Also, the recording means 2052 may compress the image information and record it onto a recording medium. Also, the communication means 2053 may compress the image information and transmit the compressed image information to an external PC connected thereto through the internet.

Further, data transferred from sub folders may be compressed after the transferring process or after the outputting process. Further, the compressed data may be stored either in the image-information storage portion 207 or in other recording mediums. In this case, the image processing device 200 includes compressing means for compressing image information, and the compressing means compresses image information and records it onto a recording medium, after the image information is transferred from the data transferring portion 204 to the outputting portion 205 or after the image information is output from the outputting portion 205. The compressing means may be realized by an MPU, a memory or the like. The aforementioned procedure may be generally realized by software which is recorded in a recording medium such as a ROM. However, it may be realized by hardware (a dedicated circuit). Here, the “recording medium” may be the image-information storage portion 207.

Hereinafter, the operation of the image-information transfer controlling portion 210 will be described in detail.

It is assumed that image information has been successively accumulated in the image-information storage portion 207 and the data transferring portion 204 has been reading printing image data from the data storage portion 203 and transferring it to the outputting portion 205.

When all the data stored in the data storage portion 203 has been transferred and, thus, there is no data to be transferred in the data storage portion 203, the data transferring portion 204 determines whether or not there is data to be transferred in the data storage portion 203 and, if there is no data to be transferred therein, it transmits information about the fact that “there is no printing image data to be transferred, in the data storage portion 203”, to the image-information transfer controlling portion 210. On receiving the information about the fact that “there is no printing image data to be transferred, in the data storage portion 203”, the image-information transfer controlling portion 210 commands the data transferring portion 204 to read image information from the image-information storage portion 207 and transfer it to the outputting portion 205.

As described above, according to the present embodiment, the image forming system can generate a notification of reduction of the free space of the hot folder and also can output image information therefrom for securing a free space of the hot folder.

### Other Examples of the Fifth Embodiment

While, in the fifth embodiment, the data transferring portion 204 determines whether or not there is data to be transferred in the data storage portion 203 and, if there is no data to be transferred therein, it transmits information about the fact that “there is no printing image data to be transferred, in the data storage portion 203”, to the image-information transfer controlling portion 210, the image-information transfer controlling portion 210 may determine whether or not there is data to be transferred in the data storage portion 203.

Further, while, in the fifth embodiment, the image-information transfer controlling portion 210 has been described as being structured separately from the data transferring portion 204, the data transferring portion 204 may have the functions of the image-information transfer controlling portion 210.

Further, while, in the fifth embodiment, the notification portion 209 displays information on the liquid crystal display, it may output a voice for making a notification to the user. In this case, the notification portion 209 reads voice information pre-stored in a memory and transmits it to a speaker. The voice information may be, for example, “the free space of the hot folder has been reduced, please output image information”. The speaker outputs a voice on the basis of the voice information. The technique for outputting the voice is a conventional technique and description thereof is omitted herein. With this structure, the user can recognize the state of the free space of the hot folder by hearing the voice, even when the user can not always check the liquid crystal display.

While, in the fifth embodiment, the notification portion 209 displays information on the liquid crystal display of the image forming device 200, the notification portion 209 may display information on the liquid crystal display of the information processing device 100. In this case, the notification portion 209 transmits information to the information processing device 100, and the operation controlling means of the liquid crystal display of the information processing device 100 displays the information on the liquid crystal display. With this structure, a user of the information processing device 100 can recognize the information on the screen of the liquid crystal display and can interrupt the transmission of image information. Then, when a free space of the image-information storage portion 207 has been secured, the user can restart the transmission of image information.

Further, in the fifth embodiment, the notification portion 209 may cause a speaker of the information processing device 100 to output a voice. In this case, the notification portion 209 transmits voice information to the information processing device 100, and the speaker of the image processing device 100 outputs a voice on the basis of the voice information. With this structure, the user of the information processing device 100 can recognize the information from the voice and can interrupt the transmission of image information, even when the user can not recognize it on the screen of the liquid crystal display.

Further, while the image forming device 200 creates and stores “printing image data”, it may also store “the process information about the printing image data” along therewith.

Further, while the timing of outputting image information from the image-information storage portion 207 has been described as being when “there is no printing image data in the data storage portion 203” and the like, the timing of outputting is not limited thereto and may be when the outputting process (or the transferring process) for a single image or a single purchase order has been completed. Also, it goes without saying that the timing may be changed in accordance with a command from an operator.

Further, while the hot folder is created in the image-information storage portion 207, the hot folder may be created in advance or may be created at the timing of the creation of sub folders. Also, determination as to whether or not a hot folder should be created may be performed and, on the basis of the result of determination, the hot folder may be created. Thus, the timing thereof is not particularly limited.

Further, the timing of creating a sub folder is not limited to when the aforementioned image forming device 200 receives a command for creating a sub folder. For example, a sub folder may be created, after it is determined whether or not a sub folder should be created. The timing thereof is not particularly limited.

Further, the operation of the image forming device which has been described in the fifth embodiment may be realized by software, and the software may be placed in, for example, a server and may be distributed through software downloading. Also, the software may be recorded into recording mediums such as CD-ROMs and these recording mediums may be distributed. This may be applied to all the other embodiments. Further, in the case where the operation of the image forming device according to the present embodiment is realized by software, the program is as follows. The program is a program for causing a computer to execute an image-information reception step for receiving image information including image data, an image-information accumulation step for accumulating the image information received at the image-information reception step, a determination step for determining whether or not it is necessary to secure a data storage region in a recording medium which is the destination of accumulation at the image-information accumulation step, and a notification step for generating a notification of information about the storage region, when it is determined at the determination step that it is necessary to secure a storage region.

Also, the program is a program for causing a computer to execute an image-information reception step for receiving image information including image data, an image-information accumulation step for accumulating the image information received at the image-information reception step, an image information transfer controlling step for receiving a notification of the completion of a printing process performed printing image data resulted from image processing on image data which has been acquired separately from the image information accumulated at the image-information accumulation step, a transfer step for transferring the accumulated image information, on receiving the notification at the image-information transfer controlling step and an outputting step for outputting the image information transferred at the transfer step.

What is claimed is:

1. An order monitoring system for monitoring subfolders, in which order data to be subjected to photograph processes are stored in a hot folder in units of the sub-folders, wherein whether a folder is being created or an order is already registered is checked based on a folder name of the subfolder that is arranged so that at least a first folder name indicating that a folder is being created or a second folder name indicating that an order has been already registered is selectively added, the system comprising:
event-data receiving means that receives event data which is transmitted when a folder name of the subfolder has been changed;
order checking means that checks whether or not there is a new already-registered order in the hot folder based on the folder name of the subfolder on receiving the event data; and
order-data transferring means that, when there is a new order, transfers the order data to a predetermined transfer destination in order to cause the order data to be subjected to photograph processes.

2. The order monitoring system according to claim 1, characterized in that at least a first extension indicating that the folder is being created or a second extension indicating that order has been registered therein is selectively attached to the folder names of the second folders for storing order data, and said order checking means determines whether or not orders are new already-registered orders, on the basis of the second extension.

3. The order monitoring system according to claim 2, characterized in that said event data includes data indicative of the type of the extension of the folder name.

4. The order monitoring system according to claim 1, characterized in that data stored in a folder includes image data files to be subjected to photograph processes and a command data file describing the contents of processes for the image data.

5. An order monitoring program for monitoring subfolders, in which order data to be subjected to photograph processes are stored in a hot folder in units of the sub-folders, wherein whether a folder is being created or an order is already registered is checked based on a folder name of the subfolder that is arranged so that at least a first folder name indicating that a folder is being created or a second folder name indicating that an order has been already registered is selectively added, the program causing a computer to execute the steps of:
receiving event data which is transmitted when a folder name of the subfolder has been changed;
checking whether or not there is a new already-registered order in the hot folder based on the folder name of the subfolder on receiving the event data; and
transferring, when there is a new order, the order data to a predetermined transfer destination in order to cause the order data to be subjected to photograph processes.

6. The order monitoring program according to claim 5, further causing the computer to execute the step of;
selectively attaching at least a first extension indicating that the folder is being created or a second extension indicating that an order has been registered therein, to the folder names of the second folders for storing order data, and determining whether or not orders are new already-registered orders, on the basis of the presence of the second extension.
